(19) United States
(12) Patent Application Publication
(10) Pub. No.: US 2006/0131360 A1
(43) Pub. Date: Jun. 22, 2006

(54) Thermal attach and detach methods and system for surface-mounted components

(75) Inventors: Thomas W. Durston, Reno, NV (US); Robert P. Larkin, Reno, NV (US); James D. Parsons, Reno, NV (US); Andrew Devey, Reno, NV (US); Alexander Prokop, Reno, NV (US)

Correspondence Address: KOPPEL, PATRICK & HEYBL, 555 ST. CHARLES DRIVE, SUITE 107, THOUSAND OAKS, CA, 91360, US

(73) Assignee: HEETRONIX CORP.

(21) Appl. No.: 11/290,942

(22) Filed: Nov. 29, 2005

Related U.S. Application Data
(60) Provisional application No. 60/631,913, filed on Nov. 29, 2004.
(60) Provisional application No. 60/684,539, filed on May 24, 2005.

(51) Int. Cl. A47J 36/02

(52) U.S. Cl. 228/101

(57) ABSTRACT

A thermal attach and detach method and system for surface-mounted components (SMCs) employs a planar-heater which generates heat in response to an electrical current. The heater's resistance varies with its temperature, and the resistance is read to determine heater and SMC temperature. A means of gripping an SMC is provided such that the device's I/O contacts are heated by thermal conduction from the planar-heater through and/or along the SMC's side-walls. An electrical current is provided to the planar-heater such that heat sufficient to attach/detach the I/O contacts to or from a PCB is generated. The method enables the gripping, heating, resistance monitoring and SMC temperature measuring to occur simultaneously. Several means of gripping an SMC are described, including vacuum, mechanical, adhesive and magnetic. A method which employs a heating element to heat a substrate on which SMCs may be mounted is also described.

This application claims the benefit of provisional patent application No. 60/631,913 to Durston et al., filed Nov. 29, 2004, and provisional patent application No. 60/684,539 to Durston et al., filed May 24, 2005.

### BACKGROUND OF THE INVENTION

1. Field of the Invention

This invention relates to the field of surface mounted component handling, and particularly to methods and systems for holding, thermally attaching and detaching surface-mounted components (SMCs) to and from substrates.

2. Description of the Related Art

Parts are often attached to other parts of equal or larger size using thermal processes. The parts of equal or larger size may be referred to as substrates. Thermal processes which may cause a part to attach to a substrate include gluing, soldering, bonding, brazing and welding.

The electronics industry, in particular, interconnects electrical device and integrated circuit chips called surface mounted components (SMCs) by thermally attaching their electrical I/O leads to electrically conducting circuits on and within polymer and ceramic substrates.

One of the two most common interconnect structures is called a hybrid-circuit. This is usually comprised of SMCs interconnected by bonding their electrical I/O leads or electrodes to an electrically conducting circuit on a ceramic substrate. The metal of the I/O leads is caused to attach to the electrically conducting circuit by ultrasonic and thermal means.

The most common interconnect structure—and the one used to illustrate the methods and systems described herein—is comprised of surface-mounted devices (SMDs) (any SMC with electrical I/O leads) interconnected by soldering their I/O leads to electrical circuits on a polymeric substrate called a printed circuit board (PCB). Soldering is an attachment process wherein a metal or metal mixture (called solder), when heated to an appropriate temperature, fuses with the SMD's electrical I/O leads and the electrical circuit contact points on the PCB, thus holding them together.

SMCs include hybrid-circuits, integrated circuits, discrete devices (inductors, capacitors, diodes, transistors, etc.), metal heat sinks and metal shields. Hybrid- and integrated-circuit SMDs are usually packaged within a polymer and their electrical I/O leads are extended to pins or balls located on at the edges and or on the bottom of the package.

The density of SMCs, such as SMDs, mounted on a substrate such as a printed circuit board (PCB) is increasing, as is the complexity of the circuitry within the SMDs. Higher SMC densities on PCBs have increased the demands on the methods used to hold, solder and desolder SMCs to and from PCBs, with the precision and selectivity of the handling methods being more important than ever to avoid heat spillover which could cause damage to nearby SMCs.

In addition, the replacement of lead-based solders with melting temperatures in the 183-200° C. range with higher melting temperature lead-free solders requiring process temperatures as high as 250-260° C. further reduces the margin of error. This is particularly true for Multi-Chip Modules (MCMs), which use higher melting temperature solder or epoxy processes for assembly and can be irreversibly damaged by subsequent exposure to temperatures approaching those at which the original MCM was assembled.

If an individual SMC on a PCB fails, there are two options: discard the whole PCB, or replace the SMC. In the past, the cost of individual PCBs may have been low enough to make discarding the PCB the preferred choice. However, this is no longer true in many cases.

Heating methods currently employed to attach and remove SMCs to and from PCBs in SMC fabrication and rework include: (1) hot air or nitrogen, (2) soldering irons, and (3) infrared heating. Each of these methods has a number of drawbacks, as noted below.

Hot air or nitrogen gas (400-900° C.) is emitted under pressure, after passing along a heated path wherein heat is transferred to the gas, typically by means of a resistively heated coil. This method has several disadvantages:

Since the gas is not a very efficient heat transfer mechanism, it must be well above the melting temperature of the solder to actually melt the solder. The high temperature of the gas stream is a risk to the SMC itself as well as to adjacent SMCs and the PCB.

The temperature of an exiting gas stream as it impinges on the component cannot be very accurately controlled since there is no means for measurement at the SMC/heater interface. Thus, it is not possible to accurately control desolder, solder and resolder processes or to accurately replicate the original reflow oven attachment sequence.

It is difficult to confine the heating to only the area of the target SMC. Complex nozzles and baffles have been designed to shield adjacent SMCs from damage. However, these require customization of the rework tooling for each SMC size, and hence add to the overall rework cost.

The gas jet method cannot be applied exclusively to the top of the SMC. The high temperature required due to the relatively low heat transfer efficiency of the gas causes the resulting exposure times to be longer than for direct heating of the solder, thus posing a risk to the SMC and its internal components.

There are also drawbacks associated with soldering irons. The temperature to which the SMC is heated is very difficult to control precisely because: (1) the soldering iron tip temperature is often inferred from a temperature measurement taken elsewhere on the soldering iron, and (2) measuring the temperature in this way is subject to further inaccuracy due to changes in the thermal contact between the soldering iron and the thermocouple and to the change of the thermocouple's temperature response over time. The resulting disadvantages include:

Unintentional excessive reflow of solder may occur, possibly damaging the components inside the SMC, or between pads on the PCB.

The large thermal mass of the soldering iron precludes the implementation of temperature ramps during solder/desolder operations. Such ramps are desirable to minimize thermal shock to the PCB and ideally should mimic the temperature ramps used in the original solder reflow oven.

Infrared (IR) radiating elements are activated at high power levels to cause heat energy to radiate from the IR elements to the SMC for desoldering. However:

Complex mechanisms associated with the IR elements must assist in focusing or directing the heat to the desired SMC.

the effectiveness of the IR system is dependent on the IR absorption or IR reflectivity of the SMC. Due to wide variances in the materials used for SMCs and the reflectivity of the surface coatings used on the top surface of SMCs, IR rework tools usually require a bottom-side directed heater as well. Since many current PCB assemblies have components on both sides, the bottom-side heat creates additional risk of component damage.

Monitoring and control of the SMC temperature is accomplished by IR temperature sensing devices connected to a computer-controlled power supply for the IR radiating element. The temperature reported by these devices depends on the emissivity of the SMC surface, which can vary widely with SMC material and surface properties.

It may also be necessary in some applications to heat the PCB board itself prior to attaching or removing a component, to remove moisture from the board and to minimize thermal stresses during SMC attachment and removal. This has conventionally been accomplished using hot air or nitrogen gas, or IR radiating elements. However, as noted above, gases are relatively inefficient heat transfer mediums; as such, the gas temperature must be considerably higher than the target PCB temperature. This inefficiency may also result in the need for an extended exposure time which may risk damage to the PCB and its components. Gas temperatures can also be difficult to control.

Using IR radiating elements to heat a PCB can also be problematic. IR absorption depends on surface emissivity, which depends on material and surface roughness. Due to wide variances in the materials used for PCBs, and the reflectivity of PCB surface coatings, uniform heating of the PCB—and precise control of temperature—can be difficult.

### SUMMARY OF THE INVENTION

A thermal attach and detach method and system for use with SMCs is presented which overcomes the problems noted above, by providing a means for simultaneously gripping an SMC, heating its input/output (I/O) contacts by thermal conduction, and monitoring and precisely controlling the heating temperature applied to the SMC.

The present method can be used for thermally attaching and detaching SMCs to and from a substrate by various methods, including soldering, bonding, or brazing. Though the method has a wide applicability, its use herein is explained in the context of soldering and desoldering SMDs to and from PCBs.

The present method employs a “planar-heater” heating element, which generates heat in response to an electrical current. The heater's resistance varies with its temperature, and the resistance is read to determine heater temperature and to measure SMD temperature. Means of gripping an SMD are provided such that the SMD's I/O contacts are heated by thermal conduction from the planar-heater through and/or along the side-walls of the SMD. An electrical current is provided to the planar-heater such that heat sufficient to solder/desolder the I/O contacts to or from a PCB is generated. The present method enables the gripping, heating and resistance monitoring and SMD temperature measurements to occur simultaneously.

Several means of gripping an SMD are described, including vacuum, mechanical, adhesive and magnetic. A method which employs a heating element such as a planar-heater to heat a substrate on which SMCs may be mounted is also described.

Further features and advantages of the invention will be apparent to those skilled in the art from the following detailed description, taken together with the accompanying drawings.

### BRIEF DESCRIPTION OF THE DRAWINGS

FIG. 1 is a block diagram of thermal attach and detach system per the present invention.

FIG. 2 is a perspective view of a planar-heater in accordance with the present invention.

FIG. 3 is an exploded view of a planar-heater module (PHM) and shaft assembly interface per the present invention.

FIG. 4 is a perspective view showing the PHM of FIG. 3 connected to a plunger, in which a platen is used to affix the planar-heater to the cartridge.

FIG. 5 is a perspective view of a shaft assembly and vacuum enclosure per the present invention.

FIGS. 6-9 are sectional views of possible embodiments of a shaft assembly and vacuum enclosure per the present invention, for which the vacuum is conveyed around the planar-heater and/or platen.

FIG. 10 is a sectional view of a vacuum enclosure per the present invention.

FIGS. 11-14 are sectional views of possible embodiments of a shaft assembly and vacuum enclosure per the present invention, for which the vacuum is conveyed through the planar-heater and/or platen.

FIG. 15 is a perspective view of one possible embodiment of a micro-gripper (MG) assembly per the present invention, in which the MG assembly is attached to a cartridge.

FIG. 16 is a perspective view of another possible embodiment of a MG assembly per the present invention, in which the MG assembly is attached to a cartridge.

FIG. 17 is a sectional view of a shaft assembly and MG per the present invention.

FIG. 18 is a cross-sectional view of another possible embodiment of a MG assembly per the present invention, in which the MG assembly is not attached to the cartridge, shown in its closed position.

FIG. 19 is a perspective view of the MG assembly shown in FIG. 18, in its open position.

FIG. 20 is a plan view and a corresponding sectional view of an adhesive preform per the present invention.

FIG. 21 is a sectional view of an adhesive preform per the present invention, as it might be used with an SMD.

FIG. 22 is a plan view and a corresponding sectional view of a magnetic preform per the present invention.

FIG. 23 is a sectional view of a magnetic preform per the present invention, as it might be used with an SMD.

FIG. 24 is a plan view and a corresponding sectional view of one possible implementation of a planar-heater conductive heating method for heating a substrate per the present invention.

FIG. 25 is a sectional view of the implementation shown in FIG. 27, as it might be used with a PCB.

FIG. 26 is a plan view and a corresponding sectional view of another possible implementation of a ball bath conductive heating method for heating a substrate per the present invention.

FIG. 27 is a sectional view of the implementation shown in FIG. 27, as it might be used with a PCB.

FIG. 28 is a block diagram of the power control and monitoring electronics (PCME) as might be used with the present invention.

FIG. 29 is a functional process flow diagram illustrating the operation of the PCME shown in FIG. 27.

### DETAILED DESCRIPTION OF THE INVENTION

The present invention enables SMCs to be simultaneously held, heated, positioned, thermally attached to a substrate or thermally detached and removed from a substrate, with the SMC's temperature being measured at all times. Substrates and PCBs themselves can also be heated by the present invention, to remove moisture before and minimize thermal stress during the attachment or removal of a component from the PCB, or to effect the component removal itself. A system in accordance with the invention can be hand-held or robotically deployed. It can precisely position a planar-heater on an SMC of any size, and precisely position an SMC on a substrate or grasp and pull an SMC that is to be removed from a substrate.

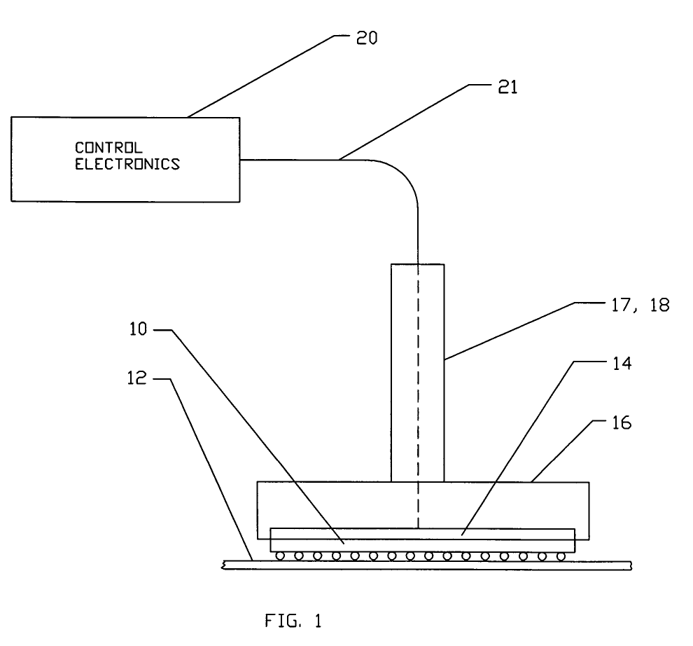

An illustration of a basic system per the present invention is shown in FIG. 1. An SMC 10 is to be attached to or detached from a substrate 12. Soldering and desoldering of SMDs from PCBs is used to explain the basic system in the following description.

The heat required to melt the solder is provided by a “planar-heater” 14—i.e., a thin planar device which generates heat in response to an electrical current, which has a resistance that varies with its temperature. The heater is typically affixed to a cartridge 16, which is in turn affixed to a shaft assembly 17, or a plunger 18 if the shaft assembly is comprised of more than a shaft and a pin holder module (discussed below). Control electronics 20 required to control planar-heater 14 is coupled to the planar-heater via wiring 21, which is routed between the electronics and the heater through the interior of shaft assembly 17.

Note that, though only SMD's are discussed herein, the present invention can be applied to any component having a planar surface.

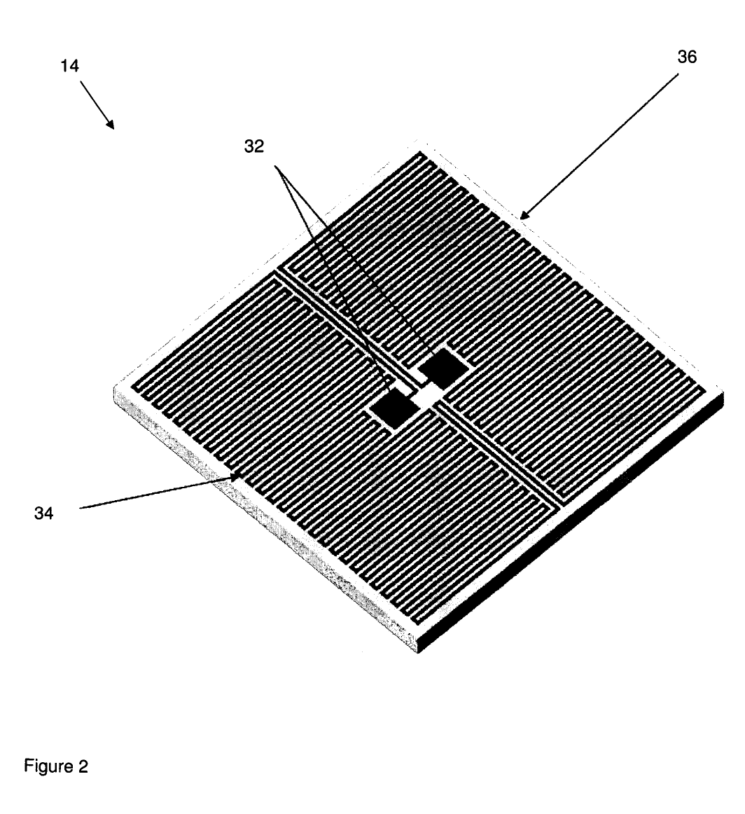

Common to all described methods is a “planar-heater” component. A typical implementation of this device is shown in FIG. 2. A planar-heater 14 is a thin-film metal circuit which includes two electrodes 32 and thin film strands 34, fabricated on a dielectric sheet 36 called a “die”. The preferred thickness of the die is greater than or equal to 0.015″, to minimize thermal mass and maximize heat transfer from the strands to the SMD. The limitation on minimum thickness is determined by mechanical durability requirements. The electrodes and strands are preferably fabricated by screen printing; thin-film growth, through a shadow mask, or thin-film growth, followed by masking and etching.

Though numerous materials can be used for die 36, materials with a high thermal conductivity are preferred. The metals used should not oxidize over the temperature range that the planar-heater is to operate, or the heater and its electrodes should be protected from oxidation by encapsulation. Two metal/die planar-heater combinations are preferred: (1) tungsten on aluminum nitride, and (2) platinum on alumina. Tungsten on aluminum nitride is preferred, as this type of die has a higher thermal conductivity and a more constant temperature coefficient than do platinum on alumina dies. Also, the expansion coefficient of tungsten strands is virtually identical to that of aluminum nitride, while the expansion coefficients of platinum and alumina differ by about 25%.

The planar-heater is thermally insulated except at its edges, so virtually all of its heat is directed through the SMD to the soldered I/O contacts. Control electronics 20 includes a power supply, which provides an excitation voltage and current to the heater, from which the heater's resistance, and thus its temperature, can be determined. As such, no additional temperature sensing mechanisms are required. Heating is accomplished by dissipating power in the strands 34. The dissipated power is the product of the excitation current supplied by electronics 20 and the resulting voltage drop across the length of the strand between the electrodes 32, the electrical connector pins which contact electrodes 32 (described below), and the wiring 21 between electronics 20 and the connector pins.

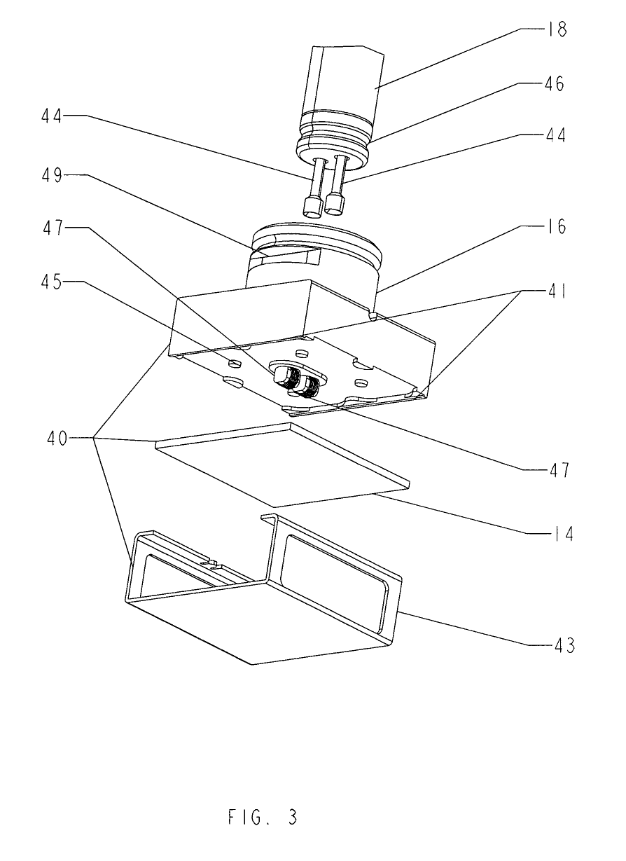

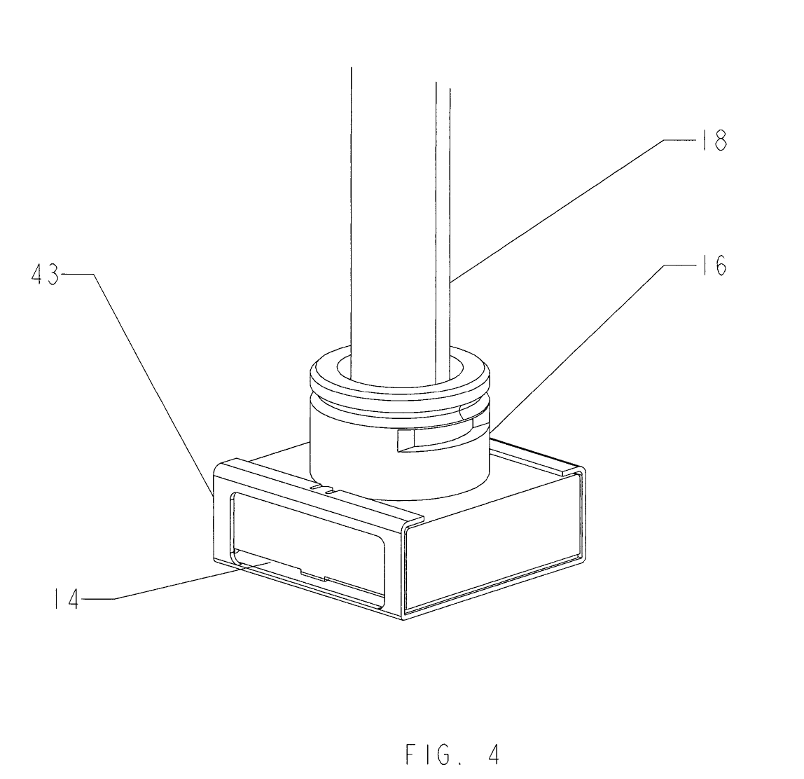

A planar-heater is typically affixed to a cartridge to form a “planar-heater module” (PHM); an exploded view of such a module is shown in FIG. 3 and a perspective view is shown in FIG. 4. A PHM 40 includes a heater 14 as shown in FIG. 2, affixed to a cartridge 16 by interference fit within the ears 41 of the cartridge 16, or by a platen 43 (illustrated in FIG. 4). The platen can be made from any metal, and is preferably ≦0.020″ thick. The cartridge is an electrically and thermally insulating elastomer or ceramic. It contains a feed-through path for spring loaded electrical connector pins 44, which extend from a shaft assembly 18 as shown in FIG. 1, to the planar-heater electrodes 32.

Protrusions (or stand-offs) 45, shown in FIG. 3, can be included to reduce heat transfer upward through the cartridge 16. Alternatively, heat transfer can be minimized by inserting low thermal conductivity ceramic or sapphire balls or a perforated/non-perforated ceramic sheet between planar-heater 14 and cartridge 16, or a combination of balls and sheet.

In use, cartridge 16 is mounted to the base of the shaft assembly 17 or a plunger 18 (described below). One way in which the cartridge can be implemented to provide electrical continuity between planar-heater 14 and electronics 20 is as follows: electrical connector pins 44 extend out of the base of the shaft assembly through an electrically and thermally insulating “pin holder module” 46, which is attached to the base of the shaft. The axis of the shaft assembly is aligned with the axis of PHM 40 as a cavity in the top of cartridge 16 is slipped over pin holder module 46 at its base. Simultaneously, electrical connector pins 44 slip into holes in cartridge 16 and extend down to planar-heater electrodes 32.

A pair of pressure spreading interface connectors 47 may be inserted between the base of pins 44 and planar-heater electrodes 32 to spread the force exerted by the spring loaded pins 44 on the electrodes over a larger area, thus reducing the pressure on electrodes 32. This substantially reduces wear on electrodes 32 and the likelihood of planar-heater cracking. Interface connectors 47 also serve to increase the cross-sectional area of electrodes 32 that can be used for current flow. The interface connectors 47 are preferably polymer or ceramic blocks (square or cylindrical), covered with electrically conductive metal to provide electrical continuity between pins 44 and electrodes 32.

Note that this arrangement is merely exemplary; numerous embodiments of PHM 40 are possible, as are the ways in which electrical continuity can be provided between planar-heater 14 and electronics 20.

The PHM can be mounted to the shaft or plunger by several methods, some of which are described below. For example, as shown in FIG. 3, a clip ring 49 may be inserted into cartridge 16 which mates with pin holder module 46; thus, pin holder module 46 snaps into clip ring 49 to connect a PHM 40 to a shaft 18.

A second method might be a retainer clip, having upper fingers which slide into corresponding grooves near the bottom of the shaft, and lower fingers which attach to corresponding slots in a planar-heater cartridge.

A third method might be to use a captive nut attachment. A threaded captive nut on the shaft is retained by a lip on the pin holder module or the shaft. The captive nut attaches to mating threads on the planar-heater cartridge, allowing the cartridge, and thus a PHM, to be attached to or detached from the shaft with two turns of the captive nut.

Another possible method is to use a bayonet attachment structure. A captive nut with bayonet slots is used to connect the shaft assembly to the PHM. The captive nut is placed on a nut spring which is supported by a lip on the pin holder module or the shaft. The captive nut is then pushed down until the top of bayonet slots are below the top of the bayonet tabs, and the captive nut is rotated so that the slots align with the tabs, thereby latching the shaft to the PHM.

A ball-detent attachment structure could also be used. Here, spring loaded balls in the planar-heater cartridge fit detents in the pin holder module. The balls are loaded by a detent spring retained within holes in the cartridge by screws. When the pin holder module detent aligns with the cartridge holes, the balls are pushed into the detent by the detent springs, thereby connecting the shaft assembly to the cartridge.

Yet another possible method to use a positive latching interference fit attachment structure, where a tapered bulge on the shaft snaps into a tapered recess in the cartridge. A tapered bulge area on the base of the plunger, just above the pin holder module, provides the guide-in and snap-in pressure for the planar-heater cartridge. The tapered bulge area may or may not be a part of the pin holder module. The maximum bulge diameter should be large enough to provide a crisp snap-in and snap-out function, but not so large as to prevent easy attachment or removal.

Several methods of gripping an SMD and holding it in close proximity to a planar-heater are described below, including vacuum, mechanical, adhesive and magnetic means. The vacuum means is described first. A vacuum can be applied to the surface of an SMD either 1) around a planar-heater and/or platen, or 2) through a planar-heater and/or platen.

When a vacuum is to be applied around the planar-heater and/or platen, the forces used to hold the SMD, and to press the planar-heater against the SMD surface, are provided by distinct and independent mechanisms. A planar-heater module used for this vacuum method should not have any protrusions beyond its bottom surface. A platen that clips or slides onto a holding surface built into the planar-heater cartridge might be advantageously employed to provide a bottom surface with no protrusions.

There are many ways in which a system in accordance with the present invention could be arranged to apply a vacuum to the surface of an SMD around the planar-heater and/or platen. Several possible embodiments are described. In these design examples, the surface of a planar-heater or platen is placed against the top surface of an SMD, and a plunger housing (described below) is pressed towards the SMD, causing a vacuum sealing surface to make contact with the SMD. Then, a vacuum pump connected to a vacuum port on the shaft assembly is turned on, causing the vacuum to hold the SMD against the heating surface of the planar-heater module. As long as the vacuum is on, the shaft and SMD will move as a single unit. When the vacuum is released, the SMD is automatically released—automatic release is possible because of the pressure exerted by the planar-heater module on the SMD, which pushes the vacuum sealing surface away from the SMD surface; alternatively, a two-way switch may be installed between the vacuum pump and vacuum port, with one switch position connecting the vacuum pump to the port and the other position venting the port to air.

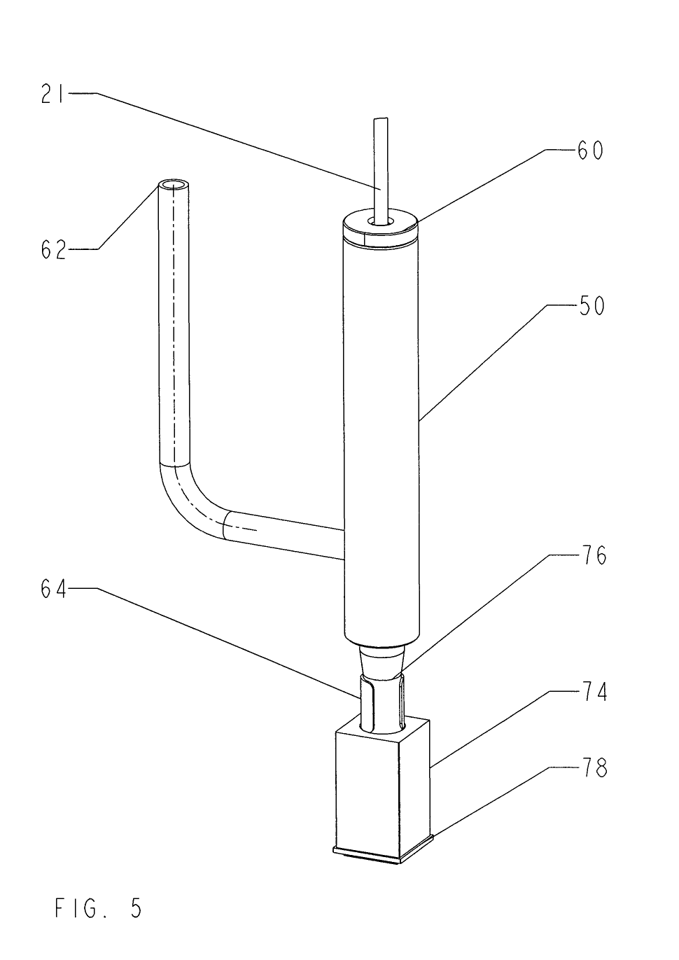

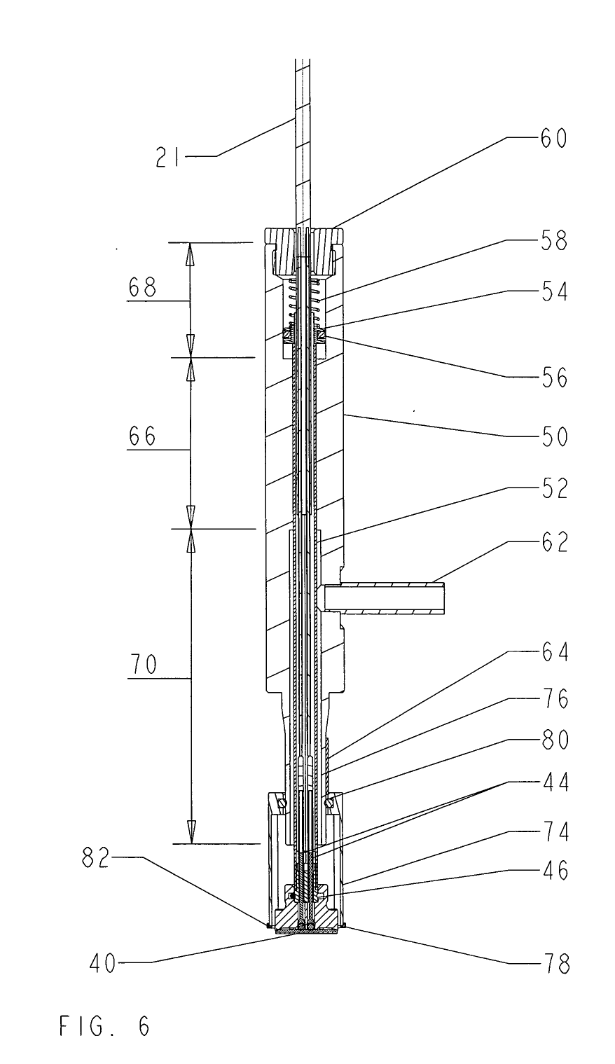

Perspective and sectional views of one possible implementation of this vacuum holding method are shown in FIGS. 5 and 6. Note that components depicted in FIGS. 3-29 which are identical or similar use like reference numbers. In FIGS. 5 and 6, the shaft assembly is comprised of nine components: a plunger housing 50, a plunger 52 (to which PHM 40 is mounted), a vacuum piston ring 54, a plunger housing piston section to vacuum piston ring vacuum seal component (VSC) 56, a plunger compression spring 58, a cap 60, a vacuum port 62, a vacuum enclosure positioning component (VEPC) 64, and a pin holder module 46 located inside plunger 52, at the shaft assembly base.

Plunger housing 50 includes a cavity (66,68,70), within which plunger 52 can slide and rotate; thus, when downward force is applied to plunger housing 50, the shaft assembly becomes shorter, and when torque is applied to the plunger housing and the plunger is stationary, the housing rotates independently of the plunger and PHM 40. Plunger compression spring 58, or, alternatively, a bellows, can transmit force through plunger 52 to the SMD surface when plunger housing 50 is pushed towards the SMD. Electrical wiring 21 from the electrical connector pins 44 to electronics 20 passes through plunger 52 and cap 60. PHM 40 fits into the bottom of plunger 52. A vacuum enclosure 74 includes a mounting surface 76 for affixing enclosure 74 to VEPC 64, which is in turn affixed to the bottom of the shaft, and a vacuum enclosure base sealing surface 78.

An O-ring groove and O-ring 80 are located near the top of vacuum enclosure 74, which forms a vacuum seal between mounting surface 76 and enclosure 74. The axial length of the O-ring seal between enclosure 74 and mounting surface 76 should be short enough to permit the enclosure axis to wobble with respect to the axis of plunger housing 50, which allows the base 82 of enclosure 74 to align the SMD surface parallel to the PHM heating surface, thus ensuring good thermal contact between these two surfaces.

Vacuum piston ring 54 is connected to the top of plunger 52. The ring limits maximum plunger travel, transmits restoring force from plunger compression spring 58 to return plunger 52 to its maximum extension when the vacuum is turned off, and provides a vacuum sealing surface for an O-ring or Teflon washer in the formation of a vacuum seal between the upper and lower volumes of plunger housing 50. The side walls of piston ring 54 are preferably machined to hold O-ring vacuum seal component 56 between ring 54 and the inner wall of plunger housing section 68 as the plunger moves up and down.

When so arranged, a vacuum applied at vacuum port 62 is conveyed to the surface of an SMD via vacuum enclosure base sealing surface 78. The force applied to the SMD surface by planar-heater module 40, created by piston ring 54 pressure on spring 58, opposes the SMD holding force created by the vacuum above the exposed surface of the SMD. These forces must be properly balanced when the SMD is suspended, or PHM 40 will ‘break’ the vacuum seal between vacuum enclosure base sealing surface 78 and the SMD surface.

VEPC 64 allows vacuum enclosure 74 to be pushed upward along the axis of plunger housing 50, so that the PHM can be connected to connector pins 44 and the PHM can be secured to the base of plunger 52. The VEPC also prevents enclosure 74 from sliding upward along mounting surface 76, after enclosure 74 has been slid back down mounting surface 76 to its operating position near the bottom of the PHM. Many types of VEPCs are practical, including, for example, a clamshell, an O-ring, a rubber band, or a clip.

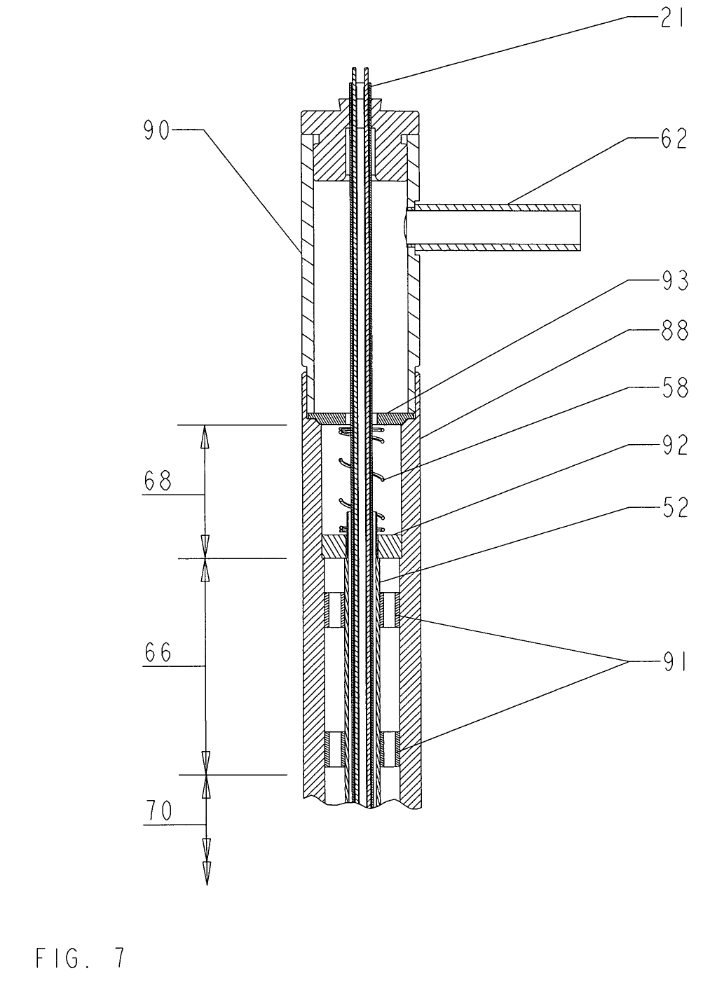

Another possible shaft assembly implementation is shown in FIG. 7. Here, the entire volume of the shaft assembly is used for the SMD holding vacuum. This shaft assembly is similar to that shown in FIG. 6, except for the following modifications:

Vacuum port 62 is located in an upper portion of plunger housing 88 (which is modified from that shown in FIG. 6).

The inside diameter (ID) of plunger housing section 66 must be increased to provide a vacuum path between the walls of section 66 and plunger 52. One preferred method of providing this vacuum path is to bore out the ID of plunger housing section 66 and insert one or more interference fitting plastic guide rings 91. There are many other means of providing these guide surfaces, but the key requirement is that guide surfaces be provided for plunger 52 at a minimum of one axial position along the inside surface of plunger housing 88.

Plunger housing 88 must now allow the entire housing volume to be evacuated through the vacuum port.

Vacuum piston ring 54 becomes a piston stop ring 92, the diameter of which must be opened up to create a vacuum path between the upper and lower volumes of the plunger housing. The force applied to the SMD surface by the PHM, created by ring 92 pressure on the spring 58 opposes the SMD holding force created by the vacuum above the exposed surface of the SMD. These forces must be properly balanced, when the SMD is suspended, or the PHM will ‘break’ the vacuum seal between enclosure 74 and the SMD surface.

Cap 60 is replaced by a 3-way can 90 and a stop washer 93. The 3-way can has three ports: two are coaxial, and the third is perpendicular to the two coaxial ports. Can 90 has an ID large enough to allow flexure of wiring 21—this permits the wires to flex inside the can when the shaft assembly is shortened. One coaxial port contains threads and is threaded into plunger housing 88. The cross-sectional opening in this threaded connector, minus the cross-sectional area of wiring 21, should be at least as large as the total cross-sectional opening in plunger stop ring 92, while still providing enough surface area to provide a holding position for stop washer 93. The opposite coaxial port preferably contains a vacuum feed-through for wiring 21; however, this could be used as the vacuum port. The perpendicular port is preferably vacuum port 62; however, this could be the vacuum feed-through for wiring 21.

Another possible embodiment is arranged such that the vacuum sealing surface of vacuum enclosure 74 is placed in intimate contact with the SMD surface. When the vacuum pump is turned on, the vacuum created by the seal between the SMD and the sealing surface of enclosure 74 simultaneously holds the SMD and forces the planar-heater or platen into contact with the SMD surface. This embodiment holds an SMD and the heating surface of a PHM against the top surface of an SMD using the same vacuum. The PHM to SMD contact force is provided by the pressure gradient across the vacuum piston ring. As long as vacuum port 62 is being pumped, the shaft assembly and the SMD will move as a single unit, and power applied to the PHM will heat the SMD. When port 62 is vented to air, the PHM will return to its original position and the shaft assembly will release the SMD.

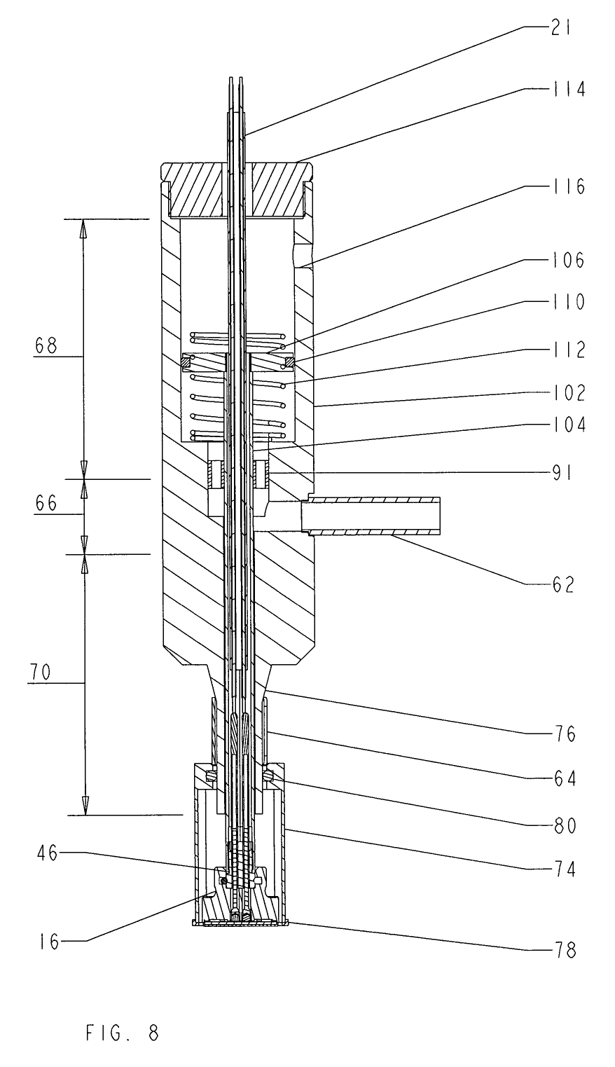

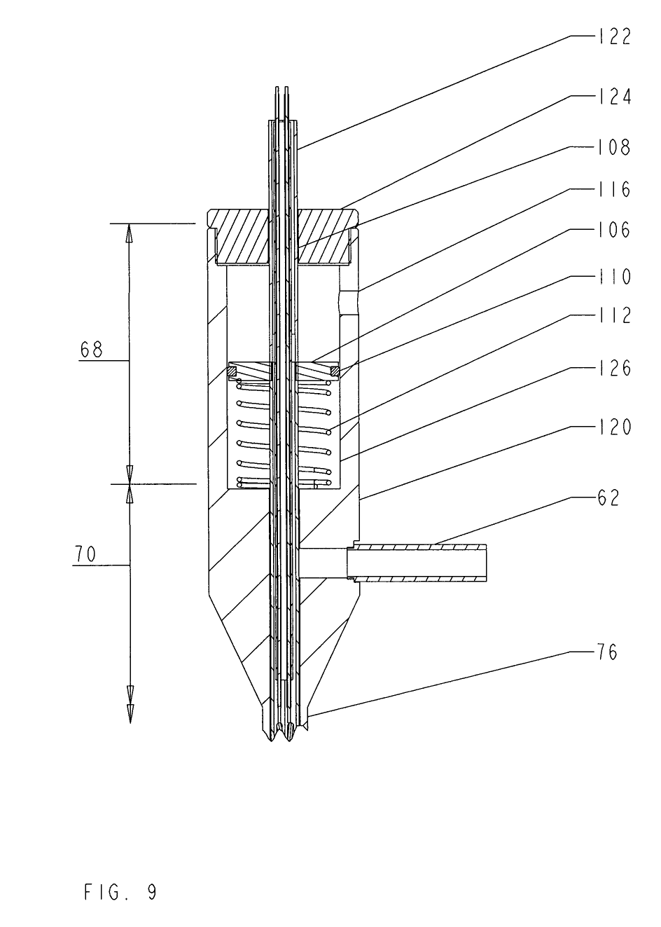

The two basic components of this embodiment are the shaft assembly and the vacuum enclosure. One possible implementation is shown in FIG. 8, and another is shown in FIG. 9.

The assembly shown in FIG. 8 is comprised of nine components: a plunger housing 102, a plunger 104, a vacuum piston ring 106, plunger guide rings 91, a plunger housing piston section to vacuum piston ring, vacuum seal component (VSC) 110, a vacuum opposing spring 112, a cap 114, a vacuum port 62, a VEPC 64, and a pin holder module 46 located inside the plunger at the shaft assembly base.

Plunger housing 102 is a hollow cylinder that contains three internal sections: a plunger housing piston section 68, a plunger guide section 66, and a vacuum enclosure attachment section 70.

When downward force due to a pressure gradient is applied to piston ring 106, the plunger extension beyond the base of housing 102 is increased, and the PHM is pressed against the top surface of the SMD. Housing 102 ensures atmospheric pressure at the top surface of piston ring 106. This is accomplished with one or more vent holes 116 in the side wall, between piston ring 106 and cap 114. The holes must be located in an axial position which is never reached by piston ring 106.

The vacuum opposing spring 112 (or bellow) can transmit a restoring force through piston ring 106 when plunger housing 102 is vented. Plunger housing 102 provides a path connecting the top surface of the SMD, the bottom surface of vacuum piston ring 106, and vacuum port 62, through which a vacuum pump connected to port 62 can create a vacuum over the exposed areas of the SMD surface between the PHM and the vacuum enclosure/SMD contact surface.

Guide rings 91 as described above can provide a vacuum path inside plunger housing guide section 66. Another method of providing a vacuum path and guide surface is to bore out and thread the guide wall to the same ID as the plunger housing ID below it; then insert one or more slotted or perforated guide rings 91 to guide the plunger and permit free air flow between the upper and lower volumes of the plunger housing. There are many other means of providing these guide surfaces; the key requirement is that guide surfaces be provided for plunger 104 at a minimum of one axial position along the inside surface of housing 102.

Plunger 104 must be longer than plunger 52 discussed above, or the axial length of section 66 must be shortened and the axial length of section 68 increased so that the plunger extends far enough beyond the housing base to permit the PHM to be attached to the plunger base. Plunger 104 provides a mounting platform for a PHM, a feed-through path for wiring 21, and an area into which pin holder module 46 can be inserted. Vacuum piston ring 106 and the ID of section 68 must be large enough to ensure that the force created by a pressure gradient across the piston ring is sufficient to overcome the opposing forces and press the heating surface of the PHM firmly against the SMD surface. The principal opposing forces are: (1) vacuum opposing spring 112 force constant, and (2) friction between the section 68 ID wall and vacuum seal component 110.

Vacuum piston ring 106, when connected to the top end of plunger 104, functions to transmit compressive force to spring 112 when the volume between the piston ring and the SMD surface is evacuated through port 62. The piston ring's bottom surface uses the top end of the spring to provide a limiting and restoring force that opposes the force caused by the pressure gradient across it. The ring also provides a vacuum sealing surface for an O-ring or Teflon washer, in the formation of a vacuum seal between the upper and lower volumes of plunger housing 102.

The side walls of vacuum piston ring 106 are machined to hold an O-ring vacuum seal component 110 between the piston ring and the inner wall of plunger housing piston section 68 as the plunger moves up and down. Vacuum seal component 110 is an O-ring or Teflon washer which forms a vacuum seal between the ID of section 68 and piston ring 106.

Vacuum opposing spring 112 provides a counter (restoring) force to plunger 104 as the plunger is forced out of the base of plunger housing 102, thus limiting the pressure applied by the PHM to the SMD surface when the assembly is evacuated through port 62. The force applied to the SMD surface by the PHM, created by the pressure gradient across vacuum piston ring 106, opposes the SMD holding force created by the vacuum above the exposed surface of the SMD. These forces must be properly balanced such that the SMD is not pressed against a PCB surface; otherwise, the PHM may push the SMD with such force that the vacuum seal between vacuum enclosure 74 and the SMD surface is broken.

VEPC 64 may be any component that allows enclosure 74 to be pushed upward along the axis of plunger housing 102, so that the PHM can be connected to the electrical connector pins and the PHM can be secured to the plunger. VEPC also prevents enclosure 74 from sliding upward along mounting surface 76, after enclosure 74 has been slid back down mounting surface 76 to its operating position just above the bottom of the PHM.

In the embodiment shown in FIG. 9, the shaft assembly is comprised of a plunger housing 120, a plunger 122, a vacuum piston ring 106, a plunger housing piston section to vacuum piston ring, vacuum seal component (VSC) 110, vacuum opposing spring 112, a cap 124, vacuum port 62, and a VEPC and pin holder module (not shown) located inside the base of plunger 122.

Plunger housing 120 is a hollow cylinder that includes plunger housing piston section 68 and vacuum enclosure attachment section 70. Housing 120 includes a cavity in which plunger 122 can slide and rotate; thus, when downward force is applied to vacuum piston ring 106 caused by a pressure gradient across the ring, the plunger extension beyond the housing base is increased, and the heating surface of the PHM is pressed against the top surface of the SMD. Housing 120 ensures that there is atmospheric pressure at the top surface of ring 106. This is accomplished with one or more vent holes 116 in the side wall, between ring 106 and cap 124. The holes must be located in an axial position which is never reached by piston ring 106.

Housing 120 also provides a cavity within which vacuum opposing spring 112 (or a bellows) can, transmit a restoring force through vacuum piston ring 106. The housing provides a path connecting the top surface of the SMD, the bottom surface of vacuum piston ring 106, and vacuum port 62, through which a vacuum pump connected to the port can create a vacuum over the exposed areas of the SMD surface between the PHM and the vacuum enclosure/SMD contact surface.

Housing 120 includes a vacuum piston ring guide surface 126 in plunger housing piston section 68. Cap 124 together with guide surface 126 keep plunger 122 aligned with housing 120. The inside wall of section 68 is one of the guide surfaces, and there is preferably at least one other guide ring 108 to provide another guide surface.

Plunger 122 must be longer than plunger 104 in FIG. 8, because it extends from the PHM to a termination position located above cap 124. Plunger 122 provides a mounting platform for a PHM, a feed-through path for the PHM wiring, and a position in its base into which a pin holder module can be inserted. Vacuum piston ring 106 and the ID of plunger housing piston section 68 must be large enough to ensure that the force created by a pressure gradient across the ring is sufficient to overcome the opposing forces and press the PHM firmly against the SMD surface. The principal opposing forces are: (1) the spring's force constant, and (2) friction between the ID of section 68 and vacuum seal component 110.

Vacuum piston ring 106 transmits compressive force to spring 112 when the volume between the ring and the SMD surface is evacuated through vacuum port 62. The ring's bottom surface uses the top end of spring 112 to provide a limiting and restoring force that opposes the force caused by the pressure gradient across it. The ring also provides a vacuum sealing surface for an O-ring or Teflon washer, in the formation of a vacuum seal between the upper and lower volumes of housing 120. The side walls of ring 106 should be machined to hold an O-ring vacuum seal component 110 between the vacuum ring and the inner wall of section 68 as plunger 122 moves up and down.

A washer (not shown), preferably Teflon, can be used in place of O-Ring 110. The washer is placed between ring 106 and spring 112. The bottom surface of the washer forms a vacuum seal to the ring surface and the outer circumference surface of the washer forms a vacuum seal to the inner wall of plunger housing piston section 68.

The force applied to the SMD surface by the heating surface of the PHM, created by the pressure gradient across piston ring 106, opposes the SMD holding force created by the vacuum above the exposed surface of the SMD. These forces must be properly balanced when the SMD is not pressed against a PCB surface, or the PHM may ‘break’ the vacuum seal between the vacuum enclosure and the SMD surface.

Cap 124 provides guide surface 108 for plunger 122 at the top of plunger housing 120. The cap preferably screws into housing 120; however, the cap could alternatively be bayonet mounted to the housing, or be mounted by a freely rotating gasket (bushing).

This shaft assembly would also include a VEPC and vacuum enclosure as described above, which allows the vacuum enclosure to be pushed upward along the plunger housing axis so that the PHM can be connected to the electrical connector pins and secured to plunger 122.

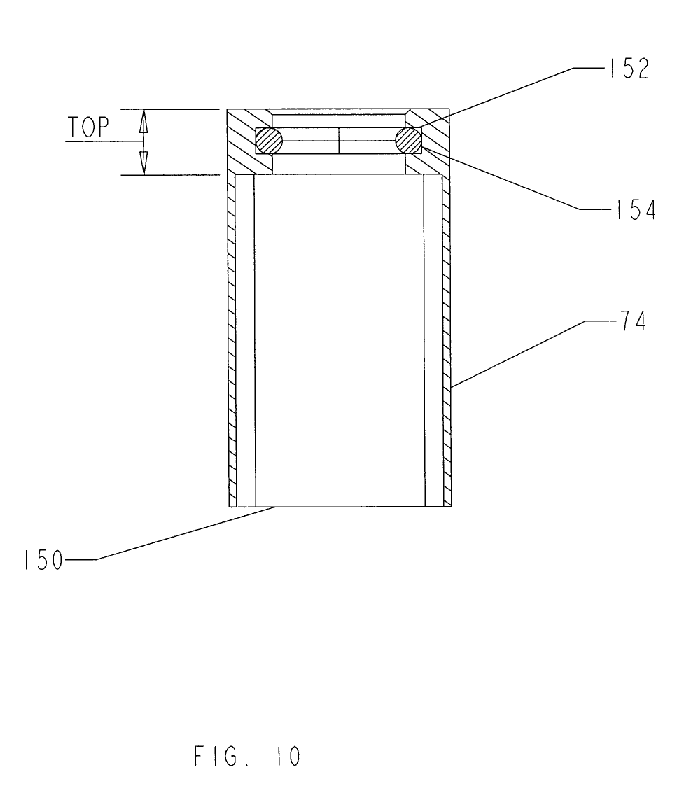

A vacuum enclosure 74 suitable for use with the assemblies shown in each of FIGS. 6-9 is illustrated is FIG. 10. The enclosure is basically a hollow box that can be made of metal, glass, ceramics, composites, or high temperature plastic. The base 150 is a flat, planar surface, which may or may not be coated with a high temperature elastomer (HTE) that reduces heat conduction to the enclosure. An opening containing an O-ring groove (ORG) 152 in the top of the enclosure contains an O-ring 154 which forms a vacuum seal between vacuum enclosure mounting surface 76 of the plunger housing and the ORG. The axial length of the O-ring seal between enclosure 74 and mounting surface 76 is short enough to permit the enclosure axis to wobble with respect to the plunger housing axis and the plunger axis; this wobble allows vacuum enclosure base 150 to align the SMD surface parallel to the PHM heating surface, thus ensuring good thermal contact between these two surfaces. The ORG 152 at the top of the vacuum enclosure can be two pieces containing opposite cambers, with the top piece of the ORG fitted or bonded to the top surface of the enclosure. Note that the vacuum enclosure shown in FIG. 10 is merely exemplary; many other vacuum enclosure embodiments are possible.

The shaft assemblies described above have the vacuum passing around the PHM to reach the SMD surface. Shaft assemblies can also provided for which the vacuum passes through the PHM and/or platen. Here, the plunger housing and plunger are a single component, and the PHM is designed to both hold and heat the SMD. The planar-heater may or may not contain holes through which a vacuum can be applied to the SMD surface; an example of each approach is discussed below.

The forces used to hold the SMD and to press the heating platen of the PHM—referred to for this embodiment as a “vacuum planar-heater module” (VPHM) (156) against the SMD surface are provided by the same mechanism—a vacuum created by pumping on a vacuum port. The force used to maintain contact between the planar-heater and the platen is independent of the vacuum used to hold the SMD. The platen/SMD interface is the vacuum sealing interface.

The VPHM and shaft assembly move as a single unit. The platen surface of the VPHM is placed in intimate contact with the SMD surface by x, y, z, θ and Φ movements of the shaft assembly. Then, the vacuum pump is turned on and switched to apply a vacuum at a vacuum port. The platen contains slots or holes through which the vacuum in the VPHM holds the SMD against the platen surface. During heating, planar-heater/platen contact is maintained by spring loaded pins that press the heater towards the platen.

As long as the vacuum port is being pumped, the shaft assembly and the SMD will move as a single unit, and power applied to the planar-heater will heat the SMD. When the port is vented to air, the VPHM will release the SMD.

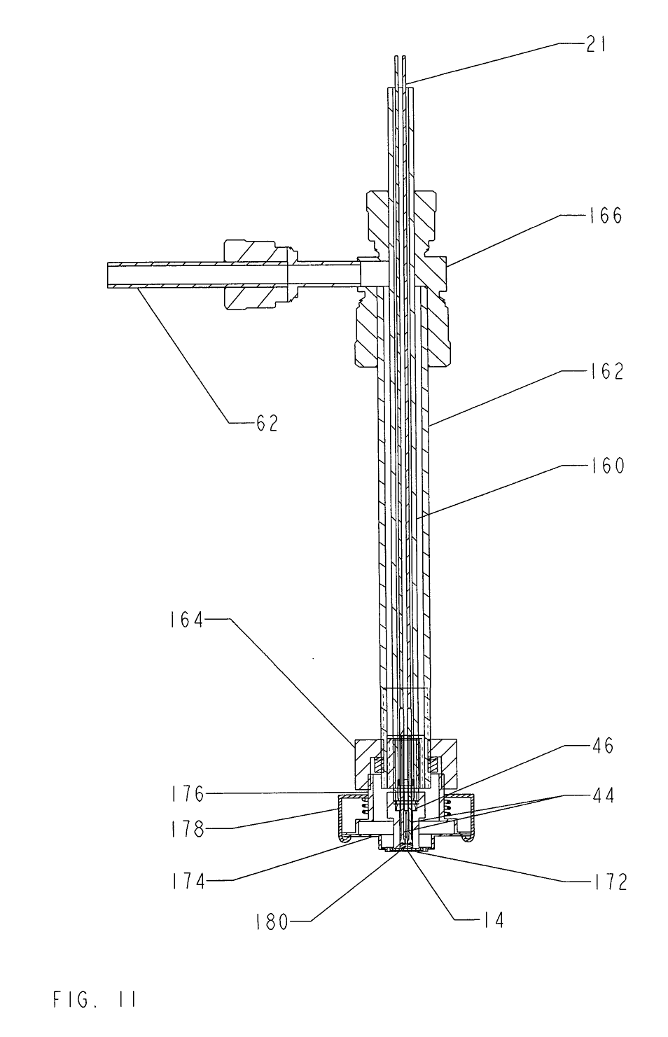

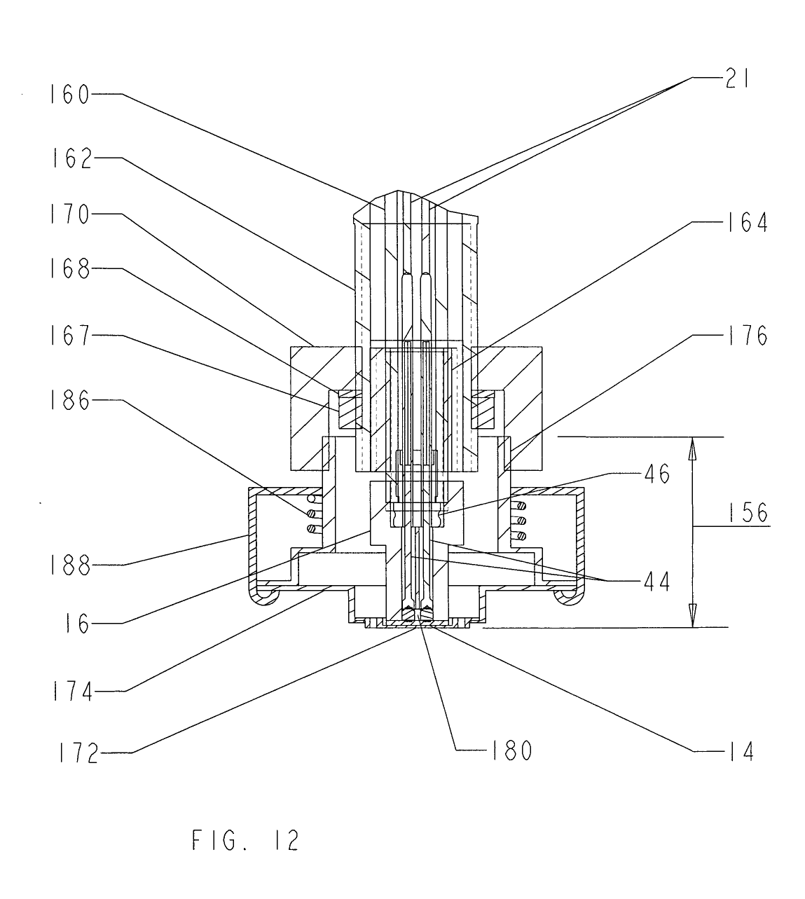

One possible shaft assembly embodiment suitable for this approach is shown in FIG. 11, with additional details visible in FIG. 12. The shaft assembly is comprised of an electrical conduit 160, a vacuum conduit 162, a vacuum conduit to vacuum-heater module connector assembly (VMCA) 164, an ultra-torr tee 166 and a vacuum port 62.

Electrical conduit 160 is a hollow cylinder that provides a feed-through path for insulated lead-wires 21 that provide electrical continuity between the system's control electronics and electrical connector pins 44 which convey power to the VPHM 156. The electrical conduit has a position at its base into which pin holder module 46 can be inserted. Conduit 160 also provides a mounting position at its base for VCMA 164, which connects the base of electrical conduit 160 to the base of vacuum conduit 162, and provides a path between the VPHM and the vacuum conduit. Vacuum conduit 162 provides a vacuum path between the VPHM and ultra-torr tee 166, and a surface for holding and positioning the shaft assembly.

The VMCA 164 is comprised of a stop nut 167, vacuum gasket 168, and a vacuum conduit to VPHM connecting nut 170. The stop nut provides a mounting surface for gasket 168 and nut 170. The gasket provides a vacuum seal between the top surface of stop nut 167 and the down facing surface of VPHM nut 170. VPHM nut 170 connects VPHM 156 to vacuum conduit 162.

The ultra-torr tee 166 contains three vacuum feed-through ports:

A vacuum conduit port which provides vacuum feed-through from vacuum conduit 162 to tee 166. The inside wall is modified to center the electrical conduit 160 with the vacuum conduit 162 at their apex.

An insulated lead-wire port which provides vacuum feed-through for lead-wire 21 from tee 166 to external electronics 20.

A vacuum port which provides vacuum feed-through for vacuum port tube 62.

VPHM 156 includes an electrical conduit to planar-heater terminal and guide assembly (TGA), a planar-heater 14, a platen 172, a platen holder 174, a platen holder to shaft assembly transition 176, and a shaft assembly transition connector assembly 178. The TGA is comprised of a cartridge 16 and, preferably, a pressure reducing connector 180. The cartridge guides the electrical connector pins 44 and electrically isolates their exposed side-walls.

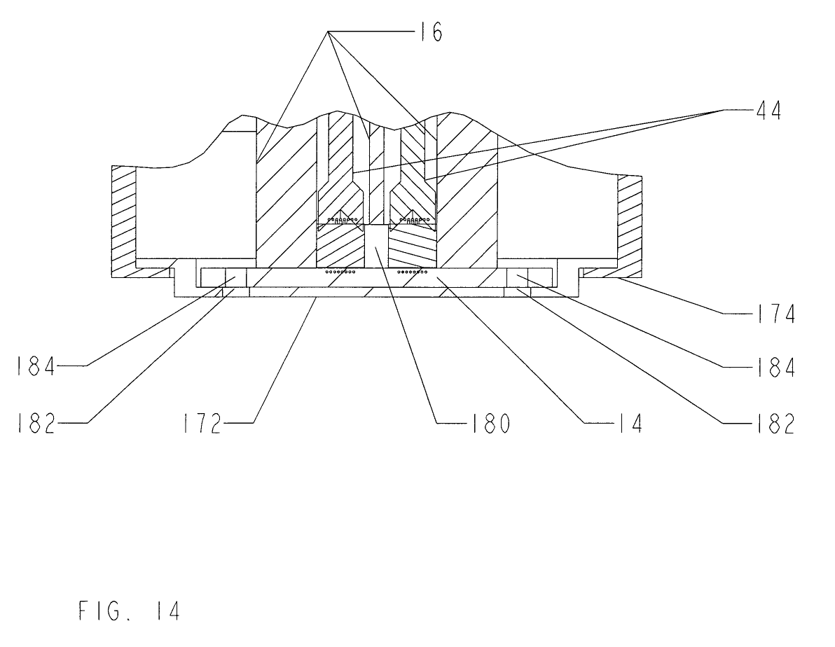

Pressure reducing connector 180 provides electrical continuity between pins 44 and planar-heater 14, and distributes the force, exerted on the planar-heater electrodes by the spring-loaded connector pins, over a much larger area. Planar-heater 14 heats platen 172. It may (as in FIG. 14) or may not (as in FIG. 12) contain vacuum feed-through holes (see platen discussion below).

Platen 172 serves to center planar-heater 14, conduct heat from the heater to an SMD surface, provide a vacuum sealing interface with an SMD, and provide a vacuum feed-through via slots or holes from the SMD surface to the VPHM. Two platen/planar-heater configurations are described:

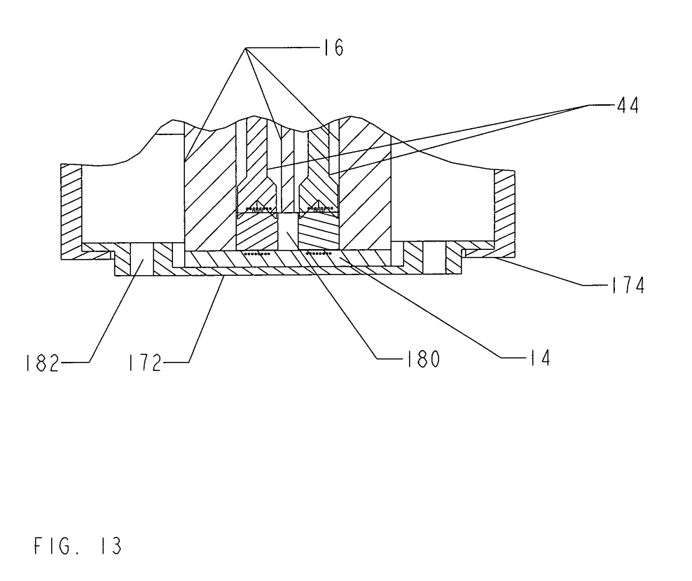

1. Platen 172 is larger than the planar-heater, as shown in FIGS. 12 and 13. In this configuration, the platen surface area may be as much as two times larger than the planar-heater surface area. A vacuum feed-through path is provided by slots 182 in the platen, around the periphery of planar-heater 14.

2. The platen 172 surface area is the same as that of the planar-heater, as shown in FIG. 14—except for the centering recess wall of the platen. A vacuum feed-through path is provided by holes 184 in the planar-heater that are aligned with slots 182 in the platen.

Platen holder 174 is preferably a high temperature thermoplastic or ceramic that provides an opening through which the platen, mounted on the platen holder rim, can make direct contact with the SMD surface. Holder 174 also provides a low thermal conductivity path between platen 172 and the platen holder to shaft assembly transition 176, and a vacuum sealing interface with the shaft assembly transition connector assembly 178. If the platen holder is a ceramic, then a gasket (not shown) should be included between the sealing surfaces of holder 174 and transition 176.

Shaft assembly transition 176 is perpendicular to the shaft assembly axis, and has a rectangular cross-section from the platen holder 174 to the spring 186 of transition connector assembly 178. Above the surface upon which spring 186 rests, transition 176 has a circular cross-section. The lip of the lower portion of transition 176 forms a vacuum interface with platen holder 174. The upper portion of transition 176 is threaded to fit VPHM nut 170 that holds and centers VPHM 156 on vacuum conduit 162. Transition 176 is not connected to the VPHM nut until it is connected to platen holder 174 with transition connector assembly 178.

Transition connector assembly 178 holds platen holder 174 tightly against shaft assembly transition 176. It is comprised of two components: spring 186 and a clip 188. The clip is open on two sides; the bottom of the other two sides of the clip are hook shaped. Connection of platen holder 174 to transition 176 is accomplished as follows: spring 186 is inserted around the circular cross-section of transition 176, as shown in FIG. 12. Then, the circular opening in the top of clip 188 is placed over transition 176 and on top of the spring. The top of the clip is then pressed against the spring and the sides of the clip are deflected outward, until the hooks extend below the outer rim of platen holder 174. The pressure on the top surface of the clip is then released and the spring pushes the clip up, thus holding the platen holder and transition 176 together.

The present invention may also employ a mechanical means to hold an SMD in contact with the platen or planar-heater surface of a PHM. One method is to use what are referred to herein as “micro-grippers” (MG). Two types are described: type 1) a “micro-gripper planar-heater module” (MGPHM), where the MGs are attached to the cartridge 16 and are part of the PHM cartridge, and type 2) MGs that are not part of the PHM and which can be moved independently of the PHM. Two examples of type 1 MGs and one example of type 2 MGs are described below, though numerous other implementations are possible.

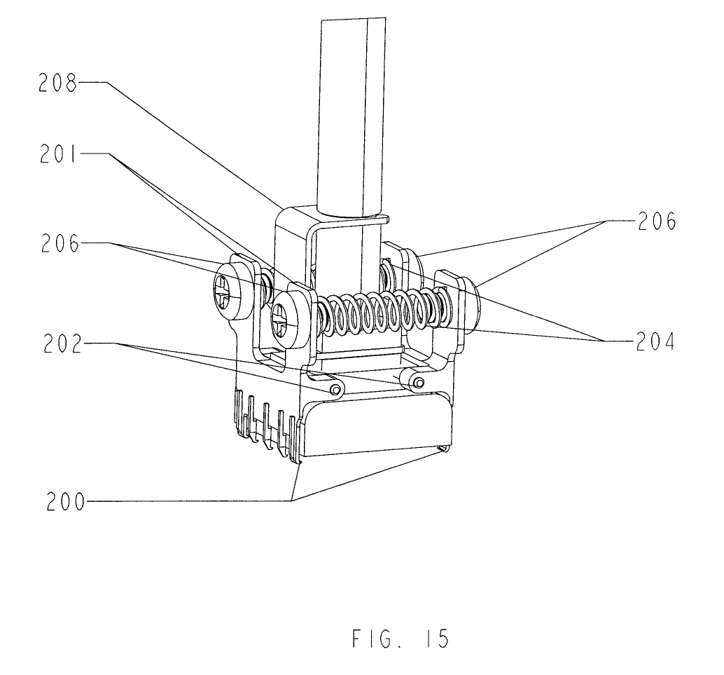

One example of a type 1 MG is shown in FIG. 15. A set of claws 200 are mounted at the bottom of a pair of arms 201, which are mounted on opposite sides of a PHM 16 by pivot rods 202 that fit through holes in the PHM. Claws 200 comprise small fingers terminated in a precision point tip. The small geometry of the claw tips allow the fingers to fit between closely spaced pins of TQFP type SMDs. The sharp precision tips on the claws provide a strong holding or grabbing force and minimize thermal loss during SMD heating. The claws 200 can be any metal or ceramic, but they should be made of materials with wear resistance suitable for the application temperature and SMD materials. For high temperatures, the best wear resistance is achieved with throated tungsten or tungsten carbide; however, there are numerous other materials that will work as well for temperatures used for SMD attach and detach (about 260° C.) and plastic or polyamide SMDs.

The micro-grippers in FIG. 15 are designed to grip by applying an outward force to arms 201 above the pivot points, such that the tops of the arms are pushed outward and the opposing claws are pushed together. This can be achieved using, for example, springs 204, which are held between opposing arms with retaining screws 206. The SMD is released when the springs are compressed by an opposing force applied to the arms. Such an opposing force can be applied by various means, including electrical, pneumatic or hydraulic actuators.

The amount of force applied to claws 200 is proportional to the force constant of springs 204. The force applied to an SMD's side-walls is easily changed by replacing the two springs. By application of a calibrated force, the actuating system can determine when the claws are attached and how much force is applied. The PHM is electrically connected to external control electronics 20, and physically connected to the bottom of a shaft, by the methods described above. For example, in FIG. 15, a retaining clip 208 secures the MGPHM to the bottom of shaft 210.

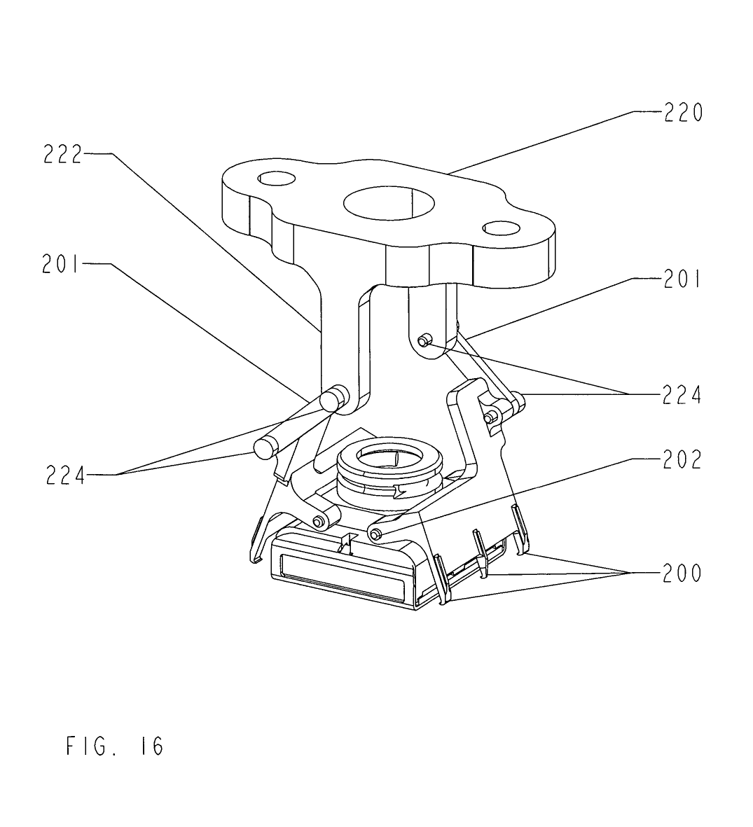

A second type 1 MG embodiment is illustrated in FIG. 16. This embodiment differs from that shown in FIG. 15 in that here, claws 200 are opened and closed by the down (open) and up (closed) motion of a yoke 220. The arms 201 of the micro-gripper and the arms 222 of the yoke are attached by pins 224 as shown.

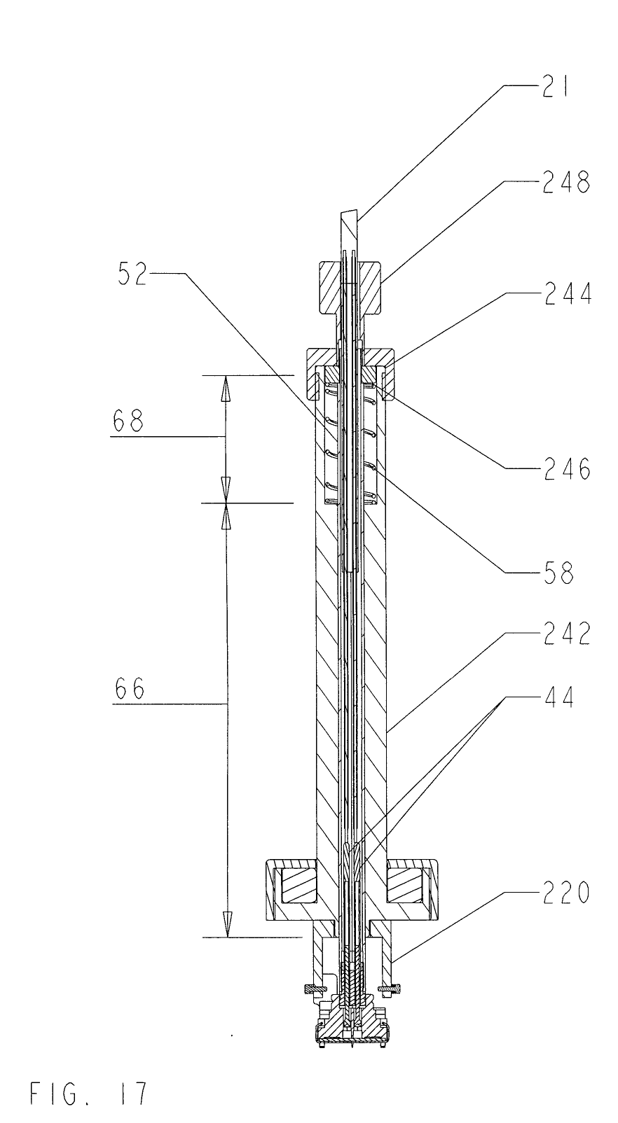

One possible shaft assembly that might be used with the micro-gripper embodiment of FIG. 16 is shown in FIG. 17. The assembly is comprised of a plunger 52 and a plunger housing 242. The base of plunger 52 attaches to the MGPHM to provide electrical continuity with the external electronics; the top of the plunger terminates at a cap nut 244. The plunger housing piston section 68 contains a plunger piston ring 246 and a spring 58 or bellows; these parts are retained within section 68 by cap nut 244.

The IDs of plunger housing guide section 66 and plunger piston ring 246 are large enough to allow the surfaces of plunger 52 and housing 242 to move in opposite directions. A hollow knob 248 fits through the cap nut and rests on piston ring 246. The ID of the lower part of the knob is large enough to allow it to fit over and slide freely over the outside wall (OD) of plunger 52. The length of the large ID in the lower part of knob 248 is longer than the axial penetration length of the plunger into it. This additional length is the distance that spring 58 can be depressed by plunger piston ring 246.

In the resting position, the claws 200 are in the closed (gripping) position. When knob 248 is depressed, plunger housing 242 is forced downward, through counter pressure by spring 58 until micro-gripper arms 201 are pushed down and the claws are in the open (non-gripping) position. When pressure on knob 248 is released, spring 58 pushes piston ring 246 back to the top of section 68, causing the claws to close.

A shaft assembly capable of providing air actuation for the micro-gripper of FIG. 16 could also be provided. For example, a pneumatic cylinder could be connected to a pair of actuating arms that are coupled to the micro-gripper's connecting arms. A piston within the pneumatic cylinder is actuated by air pressure, and could be moved up and down by applying air at ports located below and above the piston, respectively. A pressure transducer would preferably be coupled to the cylinder and arranged to transmit pressure information to external electronics 20. When the piston is pushed down, the micro-gripper claws are open, and when pushed up, the claws are closed. Motion of the piston and yoke can be monitored via the pressure transducer, such that closed loop automatic control of the micro-gripper can be effected. Note that this actuation method and implementation are merely exemplary; many schemes could be employed to operate the yoke of the micro-gripper of FIG. 16 as needed to grip and release an SMD.

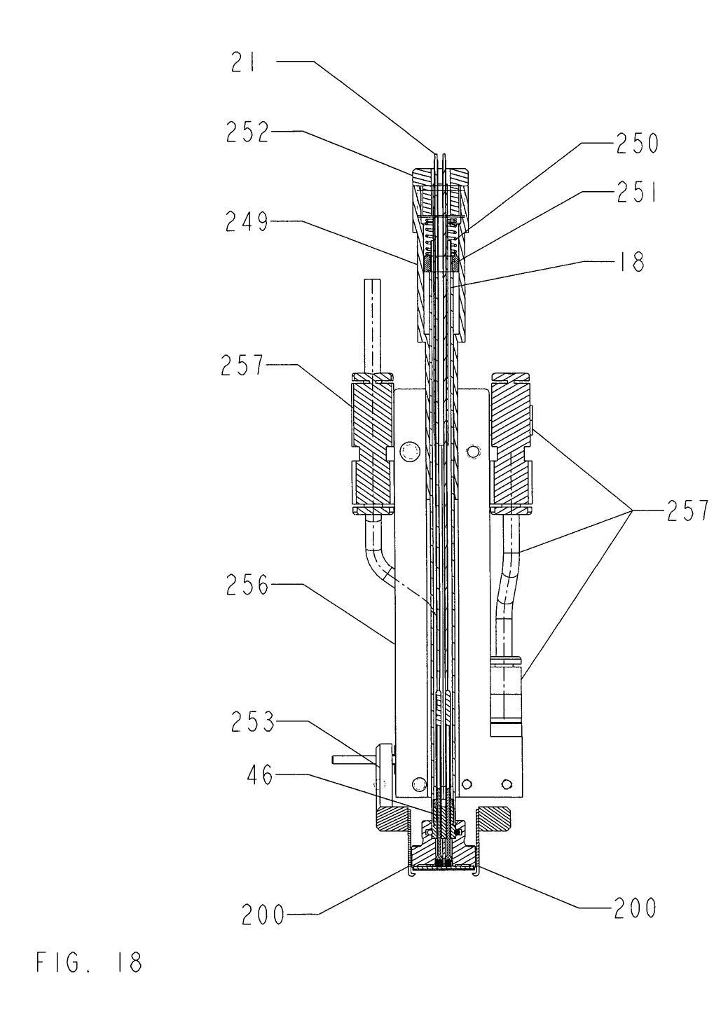

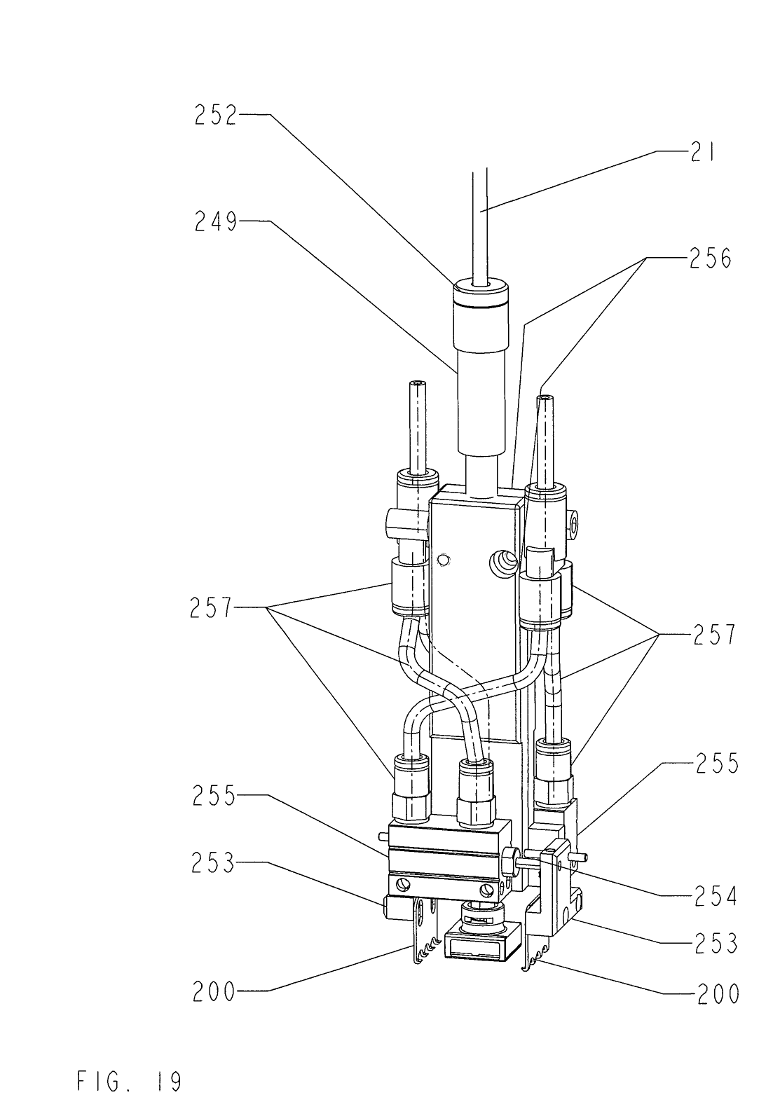

An embodiment of a type 2 MG is illustrated in FIGS. 18 and 19. This embodiment differs from those shown in FIGS. 15-17 in that the claws 200 are not attached to nor are they part of the PHM.

The shaft assembly (SA), shown in cross-section in FIG. 18, is comprised of six components: a plunger housing 249, a plunger 18, a spring 250, a plunger extension limit nut 251, a cap 252 and a pin holder module 46 located inside plunger 18, at the SA Base.

Plunger housing 249 is a hollow cylinder that performs three functions: 1) it provides a cavity within which plunger 18 can slide and rotate, 2) it provides a cavity within which spring 250 can provide a restoring force when compressed between nut 251 and cap 252 as the plunger housing is pressed downward, which causes claws 200 to be pushed down below the PHM (a bellows could be used instead of spring 250), and 3) it provides a position for cap 252 which guides electrical wires 21 out through plunger housing 249.

Plunger 18 performs two functions: 1) a feed-through path for insulated lead-wires 21, and 2) a position at its base into which pin holder module 46 can be inserted. Spring 250 provides a counter (restoring) force to plunger 18 as the plunger is forced into plunger housing 249.

Cap 252 guides the top of plunger 18 through the top end of plunger housing 249 and centers it. The cap screws into the plunger housing; however, the cap could be bayonet mounted to the plunger housing, or it could be mounted by a freely rotating gasket (bushing).

Claws 200, through arms 253, shown in FIG. 19, can be moved below the PHM/SMD interface, by applying downward pressure on plunger housing 249. The claws can also be rotated independently of the PHM.

In FIG. 19, arms 253 are connected to shafts 254 located inside a linear pneumatic actuator 255. The shafts and thus the arms and claws move in opposite directions as pneumatic pressure is applied to move them towards or away from each other. The actuator 255 is connected to plunger housing 249 by a mounting assembly 256. Controlled and regulated pneumatic pressure is supplied to the actuator through hoses and connectors 257.

The linear actuator 255 may be connected to plunger 18 instead of plunger housing 249, or it may be connected to a completely independent x, y, z, Φ and φ motion control assembly. In this embodiment, the claw arms 253, and thus the claws 200 move independently of the PHM.

All degrees of freedom of this embodiment can be controlled manually, pneumatically, electrically, magnetically or hydraulically.

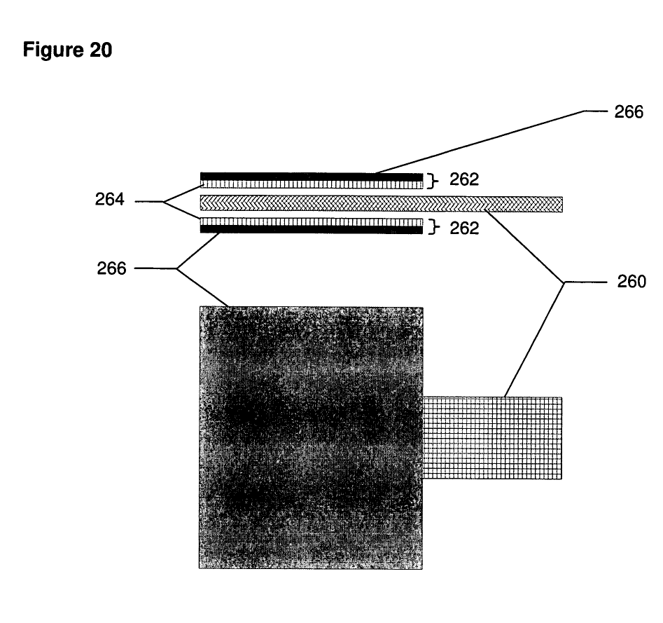

An SMD might also be gripped with the use of an adhesive preform interposed between the platen or planar-heater and the SMD. The adhesive preform attaches itself to planar surfaces and releases the same planar surfaces after heating. Plan and sectional views of an adhesive preform are shown in FIG. 20. The adhesive preform is comprised of a carrier 260, sandwiched between sheets of high temperature transfer tape 262. Carrier 260 is preferably a sheet of thermally conductive material, preferably metal, such as a fine mesh stainless steel cloth. The high temperature transfer tape, e.g. 3M products 9499 and 9882, is a rolled sheet of adhesive 264, covered on the exposed side by a removable paper backing 266.

An adhesive preform as described herein can be fabricated as follows:

1. Carrier 260 is cut into a rectangular shape, with a width approximately equal to the length of one side of the target SMD and a length sufficient to cover the length of the other side of the SMD and provide an exposed holding tab.

2. Two sheets of high temperature transfer tape 262 are cut to the approximate dimensions of the target SMD.

3. The sides of sheets 262 with exposed adhesive are attached to opposite sides of carrier 260.

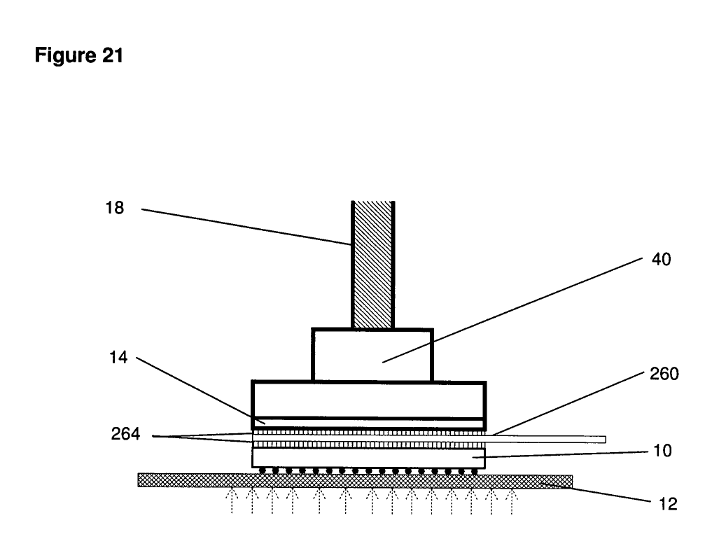

Removal of an SMD using an adhesive preform is illustrated in FIG. 21. The paper backing 266 is removed from one side of the preform, and this side is approximately centered on and attached to the target SMD 10. Next, the paper backing is removed from the other sheet. A platen or planar-heater 14 (an exposed planar-heater surface is used for illustration) is pressed onto the top surface of the SMD. The planar-heater is part of a PHM 40, connected to a shaft assembly 18 that contains the insulated lead-wires 21.

Desoldering SMD 10 and the separation of the SMD from the planar-heater surface and adhesive preform disposal proceeds as follows. After SMD 10 is heated and desoldered from PCB 12, the shaft assembly is lifted and the SMD is removed from the PCB and the SMD is then separated from the surface of planar-heater 14. The adhesive preform is then peeled from the surface it is still in contact with, leaving virtually no adhesive residue on the surfaces of the planar-heater or target SMD, due primarily to the carrier permeations which allow the adhesive from both sheets to bond to each other, and the fact that the adhesive becomes weaker and less elastic after exposure to high temperature.

A magnetic approach might also be used to grip an SMD in accordance with the invention. This method uses a magnet and a magnetic preform to attach the surface of an SMD to a platen or planar-heater surface. The magnet can be a permanent magnet or an electromagnet. The magnetic preform adhesively attaches to an SMD surface, and is magnetically held against the surface of a planar-heater or platen. The magnet can be positioned on the top surface of the PHM or within the PHM, or it can be the platen itself.

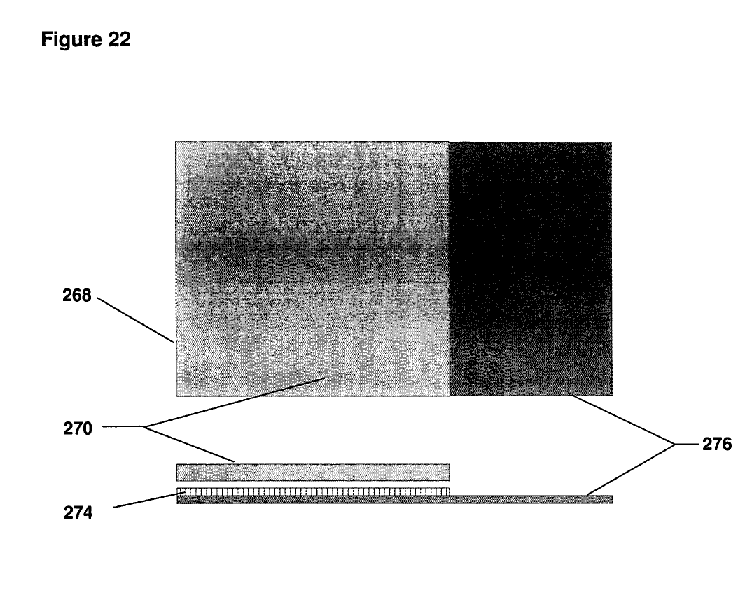

One possible embodiment of a magnetic preform 268 in accordance with the present invention is shown in plan and sectional views in FIG. 22. It is comprised of a carrier 270, with a sheet of high temperature transfer tape 272 on one side. The carrier is preferably a permeated or unpermeated sheet of thermally conductive material (preferably metal), that is magnetic or is coated with a magnetic material. High temperature transfer tape 272 comprises a rolled sheet of adhesive 274, which is covered on the exposed side by a removable paper backing 276. Preparation for SMD removal comprises removing paper backing 276 from adhesive 274, after which the adhesive surface of the magnetic preform is attached to the target SMD.

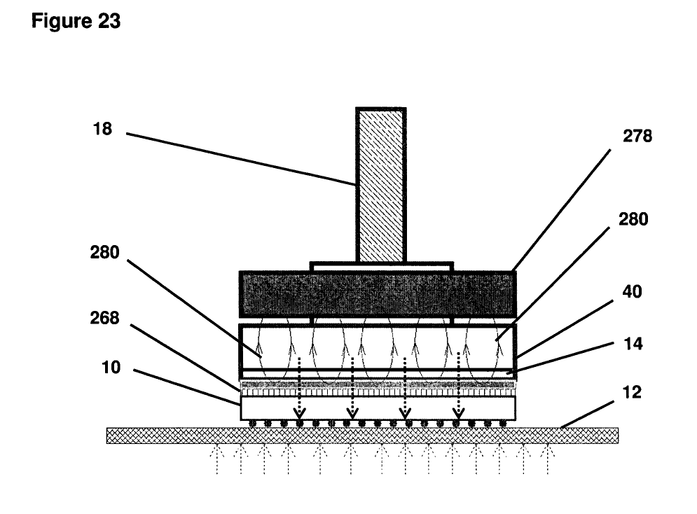

FIG. 23 depicts a magnetic preform 268 as it might be used in practice. In this illustration, the planar-heater 14 is deployed by a PHM 40—which has a magnet 278 with a hollow center resting on its top surface—connected to a shaft assembly 18 that contains insulated lead-wires 21. When the planar-heater is held in close proximity to carrier 270, the magnetic attraction pulls them together. A permanent magnet or electromagnet will not induce a current in the circuitry on PCB 12 or in the integrated circuit of SMD 10, because of the symmetry of the magnetic field; the magnetic field lines 280 are shown in FIG. 23.

Removal of the target SMD and magnetic preform 268 disposal is as follows. First, the SMD is heated until desoldered from PCB 12, and is lifted away from the PCB. Second, the magnetic preform with the SMD attached is slid off the surface of planar-heater 14 or platen, using the tab on carrier 270. Third, the adhesive 274 is peeled from the surface of SMD 10, leaving virtually no adhesive residue on the SMD. If an electromagnet is used instead of a permanent magnet, the SMD would be released from the planar-heater surface when the current through the electromagnet is switched OFF.

The present invention can also be used to heat a substrate, such as a PCB. This can be useful to, for example, drive out moisture and reduce thermal stresses that might be induced in a PCB when using the SMD rework methods described above. The substrate heating methods described below can be used to achieve temperatures of up to 300° C. The heating methods will be illustrated in the context of SMD technology, though they can be used for other applications as well.

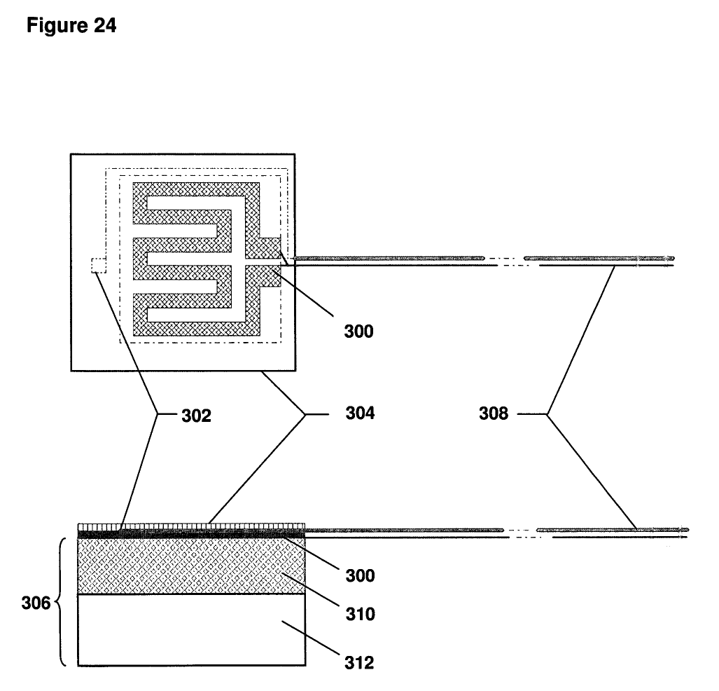

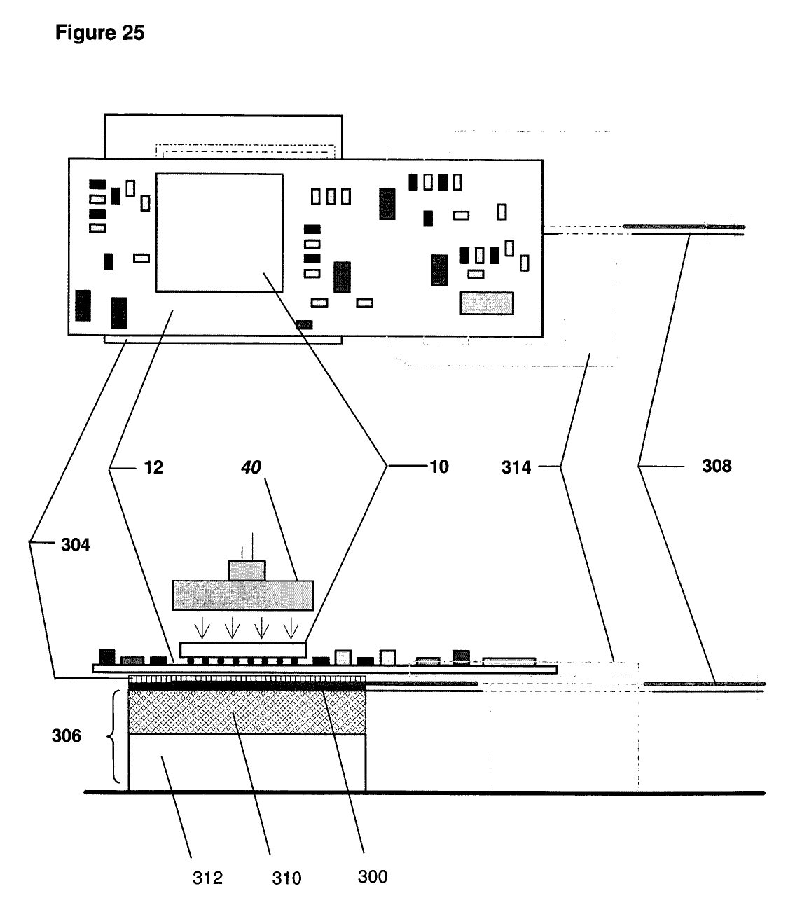

Two conductive heating methods are described: (1) planar-heater, and (2) ball bath heater. Both methods employ the same control circuitry. Plan and sectional views illustrating the planar-heater conductive heating method are shown in FIGS. 24 and 25. This method supports and heats PCBs that have SMDs on one surface only. The method requires five components: a planar-heater 300, a temperature sensor 302, a platen 304, a support assembly 306, and a controller (not shown). Planar-heater 300 employs a thin or thick film metal strand pattern, with wiring 308 connecting the heater electrodes to the controller. The planar-heater operates as described above, providing heat by resistive power dissipation.

Temperature sensor 302 is attached to the insulating material of planar-heater 300, or to the platen 304, with a high temperature adhesive. The signal from the temperature sensor is routed back to the controller via wiring 308; the controller is arranged to use the temperature sensor signal to determine the power required for planar-heater 300 to achieve and maintain a target temperature. Examples of possible temperature sensors include thermocouples and resistance temperature detectors (RTDs).

The platen 304 is attached to planar-heater 300 as shown in FIG. 24, and conducts heat from the planar-heater to PCB 12 as shown in FIG. 25. Platen 304 may or may not be in contact with the planar-heater strands and electrodes: if the platen is electrically isolated from the planar-heater, it can be a metal or a high thermal conductivity ceramic; if not, the platen must be an electrically insulating, high thermal conductivity ceramic such as AlN, beryllium oxide and silicon carbide. The surface area of the platen is preferably larger than the surface area of the planar-heater.

Support assembly 306 is comprised of a thermal insulator 310 and a support base 312. Thermal insulator 310 prevents heat generated by planar-heater 300 from conducting away from the PCB. Ideally, the surface area of thermal insulator 310 should be the same as or larger than that of platen 304, for maximum PCB heating uniformity and minimum planar-heater power requirements. However, the surface area of thermal insulator 310 can be less than half that of platen 304 and still provide satisfactory heating uniformity at temperatures below 300° C. FIG. 25 depicts a preheated PCB 12 held on platen 304 by a PCB holder 314, with SMD 10 deployed for soldering or just removed after desoldering.

The controller provides power, communication and control needed for the operation and control of the planar-heater conductive heating system. In operation, the controller receives a signal from temperature sensor 302 that varies with planar-heater temperature, and is arranged to provide the current to planar-heater 300 needed to achieve a desired temperature.

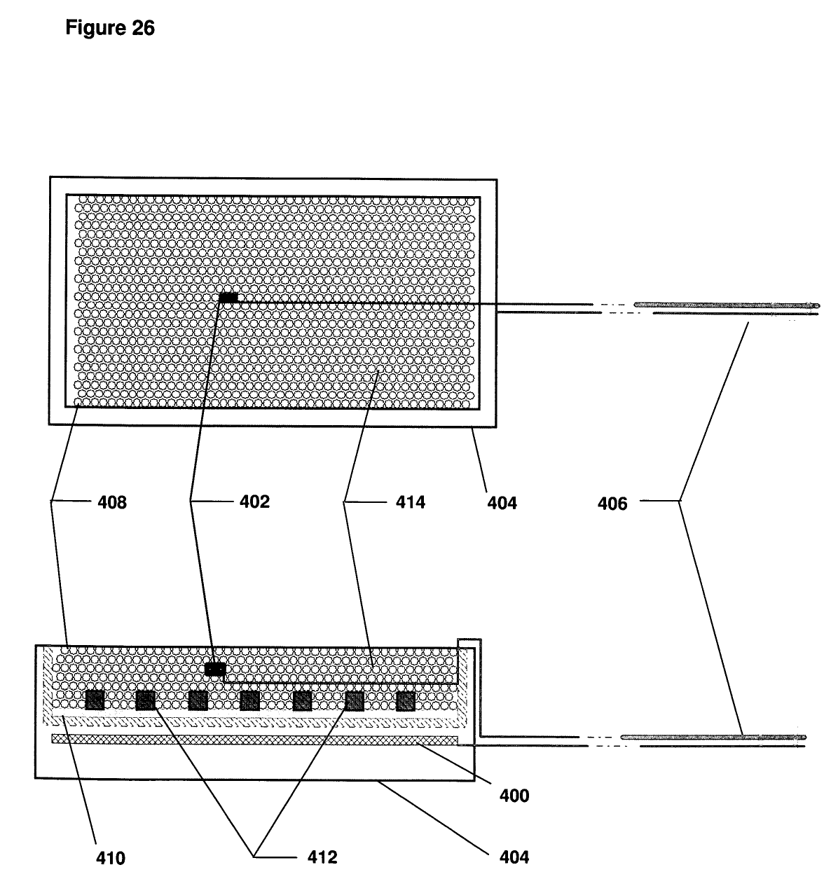

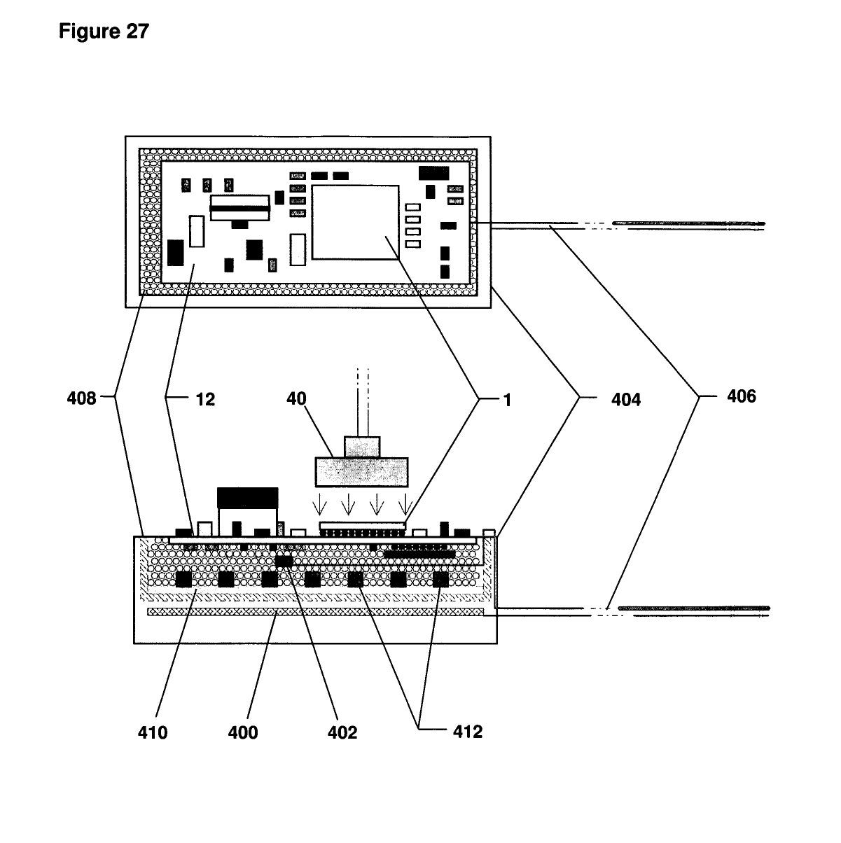

Plan and sectional views illustrating the ball bath conductive heating method are shown in FIGS. 26 and 27. This method can support and heat PCBs that have SMDs on both surfaces. The method requires four components: at least one heating element 400, a temperature sensor 402, a ball bath heating assembly 404 and a controller (not shown).

Heating element(s) 400 may be one or more probe-type heaters, a heating coil, a five-sided enclosure containing heaters in its walls, or one or more planar-heaters; in this description, heating element 400 is a planar-heater as described above. Here, however, (1) heating element 400 heats a plurality of stainless steel balls in which it is embedded, and (2) the heating element does not support the PCB.

Temperature sensor 402 is not attached to the planar-heater or platen; instead, it is embedded in a plurality of steel balls that can be attracted by a magnetic field. The signal from the temperature sensor is conveyed through wiring 406 to the controller, which uses the signal to determine the power required for the planar-heater to achieve and maintain a target temperature.

Ball bath heating assembly 404 is comprised of a containment box 408, a magnetic base 410, one or more permanent magnets or electromagnets 412, and thermally conductive balls with magnetic properties 414; the balls are preferably electrically conductive as well. Containment box 408 contains heating element 400, magnetic base 410, temperature sensor 402, magnets 412 (unless a magnetic field can be generated from the walls of the containment box), and thermally conductive balls 414. Heating element 400 is inserted at the base of the containment box, magnetic base 410 is placed on top of the heating element, and magnets 412 are arrayed on top of the magnetic base. The containment box is then filled with thermally conductive balls 414. Magnetic base 410 holds magnets 412 in prescribed positions, and the magnets hold the thermally conductive balls in position and prevents them from migrating.

Thermally conductive balls 414 support and heat PCB 12 by transferring heat from heating element 400. The thermally conductive balls, typically about 0.075″ in diameter, conform themselves to an irregular surface such as a PCB surface populated with SMDs and other components, thereby providing uniform heat transfer to irregular surfaces. The controller would be similar to that described above for the planar-heater conductive heating method: the controller receives a signal from temperature sensor 402 that varies with the temperature of thermally conductive balls 414, and is arranged to provide the current to heating element 400 needed to achieve a desired temperature.

As noted above, the planar-heater or heating element used in the above-described methods is operated with external electronics; these are referred to below as the “power control and monitoring electronics” (PCME). The PCME typically include a microprocessor and program memory, and are preferably arranged such that planar-heaters having different sizes and/or electrical characteristics, corresponding to different SMD sizes, for example, can be accommodated. This is preferably achieved by including a reference table function in the PCME's program memory which provides a specific current excitation profile for each planar-heater size. In this way, planar-heater size can be automatically determined by applying a known constant current through the planar-heater and measuring the resulting voltage across the heater. With a known voltage and a known current, the planar-heater resistance is calculated. Each planar-heater size has a qualified room-temperature resistance and calibration table, allowing the software in the PCME to correctly adapt to the specific planar-heater installed. Heater types and calibration tables might also be user-selectable.

Heating is accomplished by dissipating power in the strands of a planar-heater. The dissipated power is the product of the excitation current supplied by the PCME and the resulting voltage drop across the length of the strand between the electrodes 32, wiring 21 and electrical connector pins 44.

In a preferred embodiment, a constant current is supplied by the PCME during heating, to avoid thermal overshoot instabilities that can result from voltage control. The temperature of a planar-heater is directly proportional to the power per unit area dissipated in its strands. Thus, large planar-heaters require more power dissipation than smaller planar-heaters to reach the same temperature. Each planar-heater preferably has a programmed reference table as described above to provide the correct excitation current to heat a specific planar-heater size to a desired temperature. Maximum temperatures greater than 1,000° C. are possible; however, maximum temperatures of −300° C. are anticipated for SMDs.

The PCME are preferably arranged such that a pre-programmed temperature ramp and time profile can be initiated by pressing a button on the PCME controller or by depressing a foot switch. Note that if the drive circuitry is AC or pulsed DC, the strands should be patterned such that current-generated magnetic fields are cancelled in the heater. If this is not done, the planar-heaters can induce potentially damaging voltages in the target or nearby SMDs.

The voltage drop across the strand length increases with temperature by a known amount, defined by the temperature coefficient of resistance (TCR) of the strand metal. The TCR information is programmed into a microprocessor. Since the PCME is controlling and reading current and voltage supplied to the planar-heater, the PCME can continuously read the temperature of the planar-heater and adjust its excitation current such that planar-heater temperature is precisely controlled. When used for SMD rework, the controlled temperature should be just enough so that the SMD contacts are hot enough to cause the solder holding them to the PCB to flow, or to solder a new SMD to a PCB without causing the solder of one SMD contact to flow to another contact.

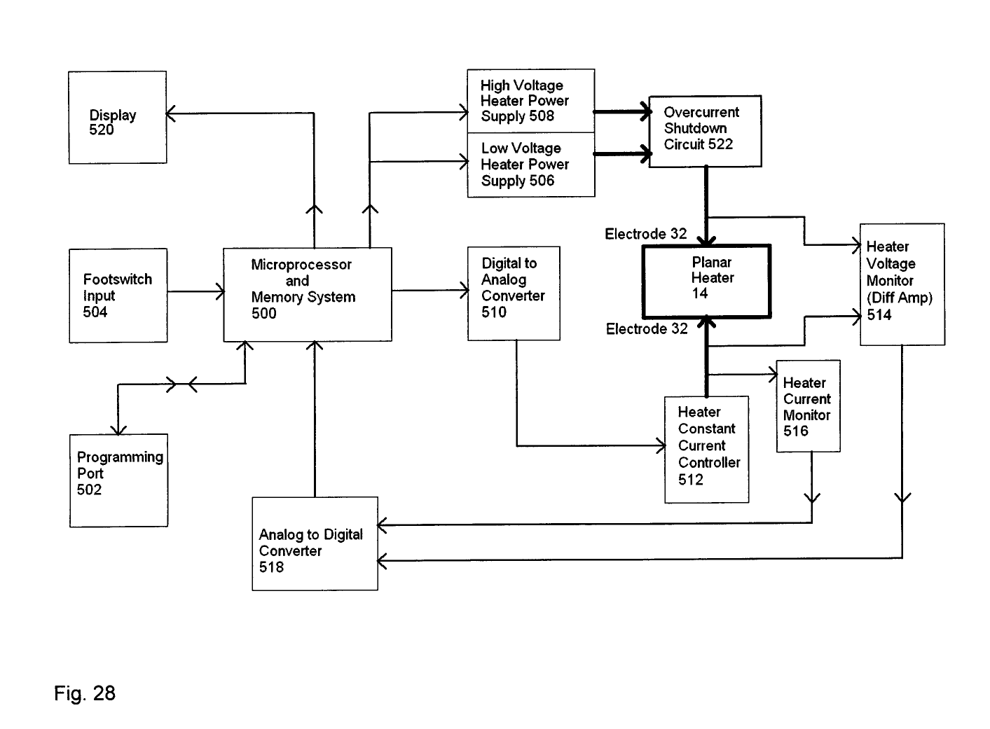

A block diagram for one possible PCME embodiment is shown in FIG. 28. The primary PCME element is the microprocessor and memory system 500 that contains the program information and planar-heater lookup tables for managing temperature control. Program data and planar-heater equation lookup tables are entered via a programming port 502 and saved in non-volatile memory. Operation is started and stopped via a footswitch input 504; the footswitch can be one or more switch contacts or a variable resistance device.

Once the footswitch is depressed, planar-heater power supplies 506 and 508 are enabled; these can be a single variable power supply, or separate power supplies as shown. The microprocessor provides control words to a digital-to-analog converter (DAC) 510, which sets the planar-heater current via a constant current controller 512, which ensures that a precision-regulated current is supplied to the planar-heater. The feedback mechanism for closed-loop control of the planar-heater temperature consists of a heater voltage monitor 514, typically a differential amplifier, and a heater current monitor 516. The outputs of circuits 514 and 516 are sent to microprocessor 500 via an analog-to-digital converter (ADC) 518 for measurement. The digitized current and voltage values are used by microprocessor 500 to calculate resistance and power, and are converted to temperature via the appropriate lookup table for the planar-heater type in use. The entire process is managed by microprocessor and memory system 500, with status information preferably provided to a display 520 for a user to monitor. An overcurrent shutdown circuit 522 can be used to prevent excessive currents in the case of malfunction in the wiring, planar-heaters, or other circuit failures, by disconnecting the power supplies if the current exceeds a predetermined value.

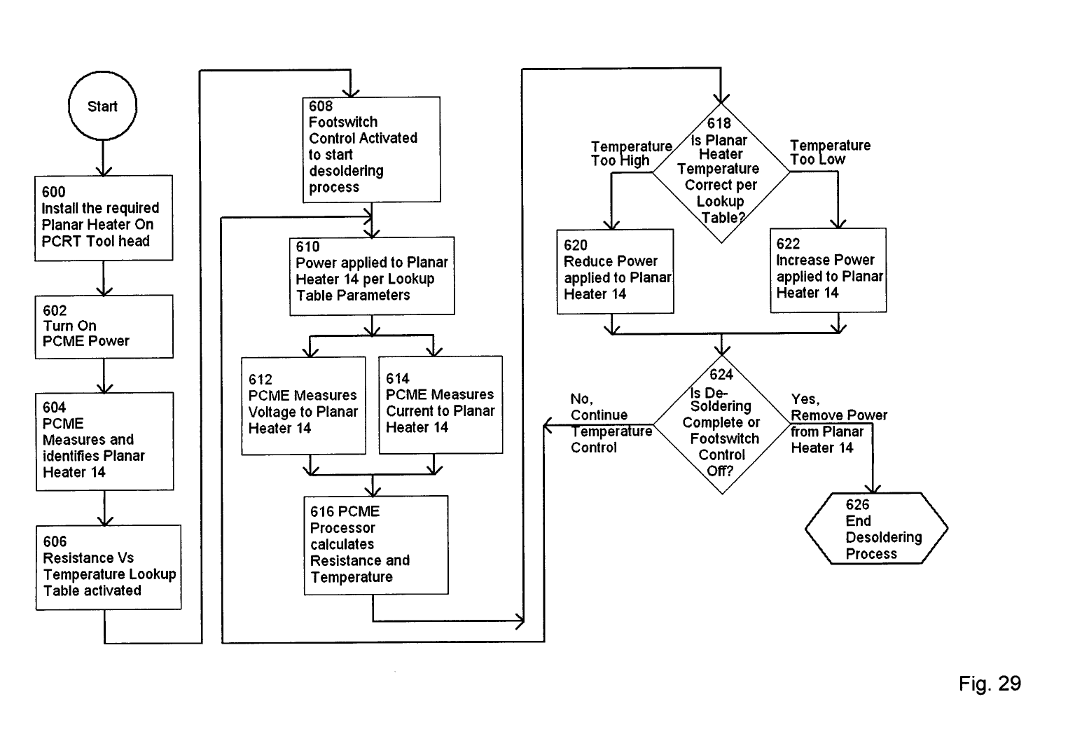

A PCME functional process flow diagram is shown in FIG. 29. User-initiated steps are 600, 602 and 608. Microprocessor and memory system 500 performs steps 604, 606, and 610-626.

The soldering or desoldering process is terminated at decision block 624. If the footswitch is released, or a predetermined “end of desoldering” event occurs (including but not limited to timer time-out, detection of sudden rise in temperature, or loss of current control), the decision block path goes to “end desoldering” 626, where power to planar-heater 14 is removed for cool down.

Not included in this functional description are ancillary functions such as calibration and programming processes, data logging of process measurements (voltage, current, resistance, temperature, power, time, planar-heater type, calendar date, firmware version, etc.), and additional user interfaces for control of the desoldering process (voice activation, multiple heater controls for top and bottom heating, custom event programming, etc.).

Note that the block and flow diagrams of FIGS. 28 and 29 are merely exemplary; there are numerous ways in which the methods of the present invention could be implemented.

While particular embodiments of the invention have been shown and described, numerous variations and alternate embodiments will occur to those skilled in the art. Accordingly, it is intended that the invention be limited only in terms of the appended claims.

We claim:

1. A method of thermally attaching or detaching a surface-mounted component (SMC) having a planar top surface to or from a substrates, comprising:
providing a planar-heater which generates heat in response to an electrical current, said heater's resistance varying with its temperature;
providing a cartridge to which said planar-heater is affixed;
gripping a SMC such that its contact interface with said substrate is heated by thermal conduction from said planar-heater through and/or along said SMC's side-walls;
providing an electrical current to said planar-heater such that heat sufficient to cause attachment or detachment of said contact interface is generated;
reading the resistance of said planar-heater to determine its temperature; and
determining the temperature of the SMC based on said resistance reading;
such that said gripping, heating, resistance reading and SMC temperature determining occur simultaneously.

2. The method of claim 1, wherein said SMC comprises a surface-mounted device (SMD) and said attachment or detachment comprises soldering or desoldering said SMD's I/O contacts to or from a printed circuit board (PCB), respectively.

3. The method of claim 1, wherein said attachment or detachment comprises bonding said SMC to said substrate.

4. The method of claim 1, wherein said attachment or detachment comprises brazing said SMC to said substrate.

5. The method of claim 1, further comprising providing a low thermal conduction path between said planar-heater and said cartridge.

6. The method of claim 1, wherein said planar-heater includes a pair of electrodes through which said electrical current is provided and said electrical current is provided to said electrodes via a pair of spring-loaded electrical connector pins, further comprising providing a pressure spreading interface connector between said planar-heater electrodes and said electrical connector pins such that the area over which the force exerted by said pins on said electrodes is increased.

7. The method of claim 1, wherein said gripping of said SMC is effected using a vacuum means.

8. The method of claim 7, further comprising:
providing a shaft which includes a vacuum port;
coupling said cartridge containing said planar-heater to one end of said shaft; and
providing a vacuum seal component which is coupled to said shaft and extends around said planar-heater such that there is at least some clearance between the sides of said planar-heater and said vacuum seal component;
such that, when a vacuum is applied at said vacuum port and said vacuum seal component is positioned on the top surface of said SMC, said vacuum is conveyed to the top surface of said SMC via said shaft and said clearance such that the top surface of said SMC is gripped and heated by thermal conduction from said planar-heater through and/or along the side-walls of the SMC.

9. The method of claim 8, further comprising affixing a platen to said planar-heater such that said platen is between said heater and said SMC.

10. The method of claim 7, further comprising:
providing a shaft which includes a vacuum port;
coupling said cartridge containing said planar-heater to one end of said shaft; and
providing a vacuum seal component which is coupled to said shaft and extends around said planar-heater, said planar-heater including one or more passages between said shaft and the bottom side of said heater such that, when a vacuum is applied at said vacuum port and said vacuum seal component is positioned on the top surface of said SMC, said vacuum is conveyed to the top surface of said SMC via said shaft and said passages such that the top surface of said SMC is gripped and heated by thermal conduction from said planar-heater through and/or along the side-walls of the SMC.

11. The method of claim 7, further comprising:
providing a shaft which includes a vacuum port;
coupling said cartridge containing said planar-heater to one end of said shaft;
affixing a platen to said planar-heater such that said platen is between said heater and said SMC;
providing a vacuum seal component which is coupled to said shaft and extends around said planar-heater, said planar-heater and/or said platen including one or more passages between said shaft and the bottom side of said heater such that, when a vacuum is applied at said vacuum port and said vacuum seal component is positioned on the top surface of said SMC, said vacuum is conveyed to the top surface of said SMC via said shaft and said passages such that the top surface of said SMC is gripped and heated by thermal conduction from said planar-heater through and/or along the side-walls of the SMC.

12. The method of claim 1, wherein said gripping of said SMC is effected using mechanical means.

13. The method of claim 12, wherein said using mechanical means comprises:
providing first and second sets of claws, said claws having tips suitable for gripping respective edges of said SMC, said claws mounted on respective pivot rods on opposite sides of said cartridge such that said claw tips can be manipulated to grip and release said SMC.

14. The method of claim 13, further comprising providing a spring which is affixed to and positioned between said first and second sets of claws such that said spring exerts a force on said claws which causes said claw tips to grip said SMC.

15. The method of claim 14, further comprising providing an actuation means arranged to provide a force on said claws opposite that of said spring such that said SMC is released from said claw tips when said means is actuated.

16. The method of claim 15, wherein said actuation means comprises an electrical, pneumatic, or hydraulic actuator.

17. The method of claim 13, further comprising providing a yoke which is affixed to and positioned between said first and second sets of claws such that said claw tips are forced apart when said yoke moves downwards toward said cartridge and said claw tips are moved towards each other when said yoke moves upwards away from said cartridge.

18. The method of claim 17, further comprising providing an actuation means arranged to move said yoke up and down to grip and release said SMC, respectively, as needed.

19. The method of claim 18, wherein said actuation means comprises a pneumatic actuator.

20. The method of claim 12, wherein said using mechanical means comprises:
providing first and second sets of claws, said claws having tips suitable for gripping respective edges of said SMC, said claws mounted on respective arms on opposite sides of said cartridge and separate from said cartridge, such that said claw tips can be manipulated to grip and release said SMC independently of said cartridge.

21. The method of claim 20, wherein said method further comprises:
providing a hollow cylindrical plunger housing having a cavity within which a plunger can slide and rotate, said arms coupled to said plunger housing;
providing a hollow cylindrical plunger within said plunger housing, said plunger coupled to said cartridge such that said claws are pushed downward below said cartridge when said plunger housing is pushed downward; and
providing a spring or bellows inside the plunger housing which transmits a restoring force to the plunger when the plunger is caused to slide into the plunger housing.

22. The method of claim 21, further comprising providing an actuation means arranged to laterally move said arms together or apart such that said claws grip or release said SMC side walls, respectively, when said means is actuated.

23. The method of claim 22, wherein said actuation means comprises an electrical, pneumatic, magnetic or hydraulic actuator.

24. The method of claim 12, wherein said using mechanical means comprises using adhesive means.

25. The method of claim 24, wherein said using said adhesive means comprises:
providing an adhesive preform, comprising:
first and second sheets of high temperature double-sided transfer tape; and
a carrier adhered between said first and second sheets; and
interposing said adhesive preform between said SMC and said planar-heater such that the side of said first sheet opposite said carrier is adhered to said planar-heater or a platen on said heater, and the side of said second sheet opposite said carrier is adhered to the top surface of said SMC.

26. The method of claim 1, wherein said gripping of said SMC is effected using a magnetic means.

27. The method of claim 26, wherein said using a magnetic means comprises:
providing a magnetic preform, comprising:
a carrier comprising a sheet of material which is magnetically attractive; and
a sheet of high temperature double-sided transfer tape, one side of said sheet adhered to said carrier and the other side of said sheet adhered to the top surface of said SMC; and
providing a magnet positioned so as to magnetically attract said carrier toward said planar-heater such that the top surface of said SMC is magnetically held against said planar-heater or a platen on said heater.

28. The method of claim 27, wherein said magnet is positioned above said SMC on the side of said planar-heater opposite said SMC.

29. The method of claim 27, wherein a magnetic platen is affixed to said planar-heater such that said magnet is said platen.

30. The method of claim 27, wherein said magnet is positioned such that the resulting magnetic field is symmetric with respect to said SMC such that said magnet induces no current in said SMC's circuitry.

31. The method of claim 1, wherein said planar-heater comprises a thin film metal trace which conducts said current.

32. The method of claim 1, wherein reading said resistance comprises measuring said electrical current and measuring the voltage drop across said resistance.

33. The method of claim 1, wherein said cartridge is a thermally and electrically insulating cartridge.

34. The method of claim 1, wherein said SMC is initially soldered to said PCB, further comprising pulling on said SMC simultaneously with said gripping, heating, resistance reading and SMC temperature determining such that said SMC is lifted away from said PCB when said SMC has been desoldered.

35. The method of claim 1, further comprising:
comparing the resistance which has been read with a preset value which represents a desired planar-heater temperature; and
increasing or decreasing said electrical current so as to drive the difference between said resistance and said preset value toward zero.

36. The method of claim 35, further comprising:
providing a known test current to said planar-heater; and
providing a reference table which receives the resistance value resulting from said known test current and provides a corresponding preset value in response.

37. A method of heating a selected area of a substrate on which SMCs may be mounted, comprising:
providing a planar-heater which generates heat in response to an electrical current, said heater's resistance varying with its temperature;
providing a cartridge to which said planar-heater is affixed;
providing a thermally conductive platen;
affixing said platen to said planar-heater;
placing a selected area of a substrate to be heated into contact with said platen, said heater and platen arranged such that said platen conducts heat generated by said heater to said selected area; and
providing an electrical current to said planar-heater such that heat sufficient to heat said selected area is generated.

38. The method of claim 37, wherein said substrate is a printed circuit board (PCB).

39. The method of claim 37, further comprising:
providing a temperature sensor which provides an output that varies with the temperature of said planar-heater;
comparing said sensed temperature with a preset value which represents a desired planar-heater temperature; and
increasing or decreasing said electrical current so as to drive the difference between said sensed temperature and said preset value toward zero.

40. The method of claim 37, further comprising:
providing a thermally insulating support assembly; and
positioning said support assembly such that it supports said planar-heater, platen and substrate and reduces the amount of heat that would otherwise be conducted away from said substrate.

41. A method of heating a substrate on which integrated circuits may be mounted, comprising:
providing a planar-heater which generates heat in response to an electrical current, said heater's resistance varying with its temperature;
providing a cartridge to which said planar-heater is affixed;
providing a containment box;
placing said substrate within said containment box;
placing a plurality of thermally conductive balls into said containment box and on said substrate, said balls sized so as to conform to irregularities in the surface of said substrate;
placing said planar-heater beneath said containment box such that heat generated by said heater is uniformly distributed over said substrate by said balls; and
providing an electrical current to said planar-heater such that heat sufficient to heat said substrate is generated.

42. The method of claim 41, further comprising creating a magnetic field which prevents said balls from migrating.

43. The method of claim 42, wherein creating said magnetic field comprises:
providing a base;
arraying a plurality of magnets on said base; and
positioning said base and magnets so as to create said magnetic field.

44. The method of claim 41, further comprising:
providing a temperature sensor which provides an output that varies with the temperature of said planar-heater;
comparing said measured temperature with a preset value which represents a desired planar-heater temperature; and
increasing or decreasing said electrical current so as to drive the difference between said measured temperature and said preset value toward zero.

45. A surface-mounted component (SMC) attachment/detachment system for attaching or detaching an SMC to or from a substrate, comprising:
a planar-heater which generates heat in response to an electrical current, said heater's resistance varying with its temperature;
a cartridge to which said planar-heater is affixed;
a means for gripping an SMC such that its input/output (I/O) contacts are heated by thermal conduction from said planar-heater through and/or along the side-walls of the SMC;
a means for providing electrical current to said planar-heater such that heat sufficient to attach/detach said SMC's I/O pins to or from a substrate is generated; and
a means for reading the resistance of said heater to determine the temperature of said heater and thereby said SMC;
said system arranged such that said gripping, heating, resistance monitoring and temperature determination occur simultaneously.

46. The system of claim 45, wherein said means for gripping said SMC comprises a vacuum means.

47. The system of claim 45, wherein said means for gripping said SMC comprises a mechanical means, comprising:
first and second sets of claws, said claws having tips suitable for gripping respective edges of said SMC, said claws mounted on respective pivot rods on opposite sides of said cartridge such that said claw tips can be manipulated to grip and release said SMC;
a spring which is affixed to and positioned between said first and second sets of claws such that said spring exerts a force on said claws which causes said claw tips to grip said SMC; and
an actuation means arranged to provide a force on said claws opposite that of said spring such that said SMC is released from said claw tips when said means are actuated.

48. The system of claim 45, wherein said means for gripping said SMC comprises a mechanical means, comprising:
first and second sets of claws, said claws having tips suitable for gripping respective edges of said SMC, said claws mounted on respective pivot rods on opposite sides of said cartridge such that said claw tips can be manipulated to grip and release said SMC;
a yoke which is affixed to and positioned between said first and second sets of claws such that said claw tips are forced apart when said yoke moves downwards toward said cartridge and said claw tips are moved towards each other when said yoke moves upwards away from said cartridge.

49. The system of claim 45, wherein said means for gripping said SMC comprises a mechanical means, comprising:
first and second sets of claws, said claws having tips suitable for gripping respective edges of said SMC, said claws mounted on respective arms on opposite sides of said cartridge and separate from said cartridge, such that said claw tips can be manipulated to grip and release said SMC independently of said cartridge; and
an actuation means arranged to laterally move said arms together or apart such that said claws grip or release said SMC side walls, respectively, when said means are actuated.

50. The system of claim 45, wherein said means for gripping said SMC comprises an adhesive preform, comprising:
first and second sheets of high temperature double-sided transfer tape; and
a carrier adhered between said first and second sheets;
said adhesive preform interposed between said SMC and said planar-heater such that the side of said first sheet opposite said carrier is adhered to said planar-heater or a platen on said heater, and the side of said second sheet opposite said carrier is adhered to the top surface of said SMC.

51. The system of claim 45, wherein said means for gripping said SMC comprises a magnetic preform, comprising:
a carrier comprising a sheet of material which is magnetically attractive;
a sheet of high temperature double-sided transfer tape, one side of said sheet adhered to said carrier and the other side of said sheet adhered to the top surface of said SMC; and
a magnet positioned so as to magnetically attract said carrier toward said planar-heater such that the top surface of said SMC is magnetically held against said planar-heater or a platen on said heater.

52. The system of claim 45, wherein said SMC is initially soldered to said PCB, further comprising a means for pulling on said SMC simultaneously with said gripping, heating, resistance monitoring and temperature determination such that said SMC is lifted away from said PCB when said SMC has been desoldered.

53. The system of claim 45, further comprising:
a means for comparing said measured resistance with a preset value which represents a desired planar-heater temperature; and
a means for increasing or decreasing said electrical current to drive the difference between said measured resistance and said preset value toward zero;
said means for providing an electrical current to said planar-heater comprising:
a current source which provides a known test current to said planar-heater;
a means for measuring the voltage across said planar-heater resistance such that said resistance can be determined based on said known current and said measured voltage; and
a reference table which receives the resistance value resulting from said known electrical current and provides a corresponding preset value.

54. The system of claim 45, wherein said SMC comprises a surface-mounted device (SMD) and said attachment or detachment comprises soldering or desoldering said SMD's I/O contacts to or from a printed circuit board (PCB), respectively.

55. A system for heating a selected area of a substrate on which integrated circuits may be mounted, comprising:
a planar-heater which generates heat in response to an electrical current, said heater's resistance varying with its temperature;
a thermally conductive platen affixed to said planar-heater, said platen placed into contact with a selected area of a substrate to be heated, said heater and platen arranged such that said platen conducts heat generated by said heater to said selected area;
a means for providing an electrical current to said planar-heater such that heat sufficient to heat said substrate is generated;
a temperature sensor which provides an output that varies with the temperature of said planar-heater;
a means for comparing said sensed temperature with a preset value which represents a desired planar-heater temperature; and
a means for increasing or decreasing said electrical current so as to drive the difference between said sensed temperature and said preset value toward zero.

56. A system for heating a substrate on which integrated circuits may be mounted, comprising:
a planar-heater which generates heat in response to an electrical current, said heater's resistance varying with its temperature;
a containment box into which a substrate to be heated is placed;
a plurality of thermally conductive balls placed within said containment box and on said substrate, said balls sized so as to conform to irregularities in the surface of said substrate;
said planar-heater located beneath said containment box such that heat generated by said heater is uniformly distributed over said substrate by said balls;
a means for providing an electrical current to said planar-heater such that heat sufficient to heat said substrate is generated; and
a means for creating a magnetic field which prevents said balls from migrating;
a temperature sensor which provides an output that varies with the temperature of said planar-heater;
a means for comparing said measured temperature with a preset value which represents a desired planar-heater temperature; and
a means for increasing or decreasing said electrical current so as to drive the difference between said measured temperature and said preset value toward zero.
